(19) United States
(12) Patent Application Publication
(10) Pub. No.: US 2026/0094380 A1
(43) Pub. Date: Apr. 2, 2026

(54) SYSTEMS AND METHODS FOR NAVIGATIONAL AND INFORMATIONAL ASSISTANCE FOR DIGITAL TWINS

(71) Applicant: Matterport, Inc., Sunnyvale, CA (US)

(72) Inventor: Satyasree Muralidharan, Austin, TX (US)

(73) Assignee: Matterport, Inc., Sunnyvale, CA (US)

(21) Appl. No.: 19/081,905

(22) Filed: Mar. 17, 2025

Related U.S. Application Data
(60) Provisional application No. 63/701,500, filed on Sep. 30, 2024.

(51) Int. Cl. G06T 19/00

(52) U.S. Cl. CPC G06T 19/003

(57) ABSTRACT

A example system comprising one or more processors, and memory containing instructions to control the one or more processors to receive a 3D digital model representing a physical environment, receive a first user input, the first user input including a first verbal input to control navigation to a destination within the 3D model, translate the first verbal input into a first text query using a first machine learning model, analyze, by a second machine learning model, the first text query to determine a desired navigation, and provide one or more navigational commands to control navigation to a destination within a graphical user interface associated with the 3D model responsive to the verbal input.

### RELATED APPLICATION

This application claims the priority benefit of U.S. Provisional Ser. No. 63/701,500, filed on Sep. 30, 2024, entitled “SYSTEMS AND METHODS FOR NAVIGATIONAL AND INFORMATIONAL ASSISTANCE FOR DIGITAL TWINS,” which is incorporated by reference herein.

### FIELD OF THE INVENTION(S)

Embodiments of the present invention(s) relate to interactive 3D visualizations to provide navigational assistance information regarding a 3D modeled environment.

### BACKGROUND

Three-dimensional (3D) visualizations and walkthroughs typically enable users to view and/or engage with 3D models of a given environment. 3D model visualizations of a physical environment, such as a house, are becoming common. However, accessibility to such 3D models may be difficult for people with disabilities, including blindness, visual impairment, or those with limited motion control.

### SUMMARY

An example system comprising one or more processors, and memory containing instructions to control the one or more processors. The one or more processors may be controlled to receive a 3D digital model representing a physical environment, receive a first user input, the first user input including a first verbal input to control navigation to a destination within the 3D model, translate the first verbal input into a first text query using a first machine learning model, analyze, by a second machine learning model, the first text query to determine a desired navigation, and provide one or more navigational commands to control navigation to a destination within a graphical user interface associated with the 3D model responsive to the verbal input.

In one example, the memory containing instructions to further control the one or more processors to: generate a first verbal response describing the destination based on metadata associated with the destination and the 3D model, and provide the first verbal response. In some embodiments, the first verbal response includes a position of the destination relative to other locations within the physical environment. In one example, the first verbal response is generated based on context from the user.

In various embodiments, the first verbal input is in a non-English language. In one example, the first verbal response is in a non-English language. In some embodiments, the memory containing instructions to further control the one or more processors to: generate a textual response based on some or all of the first verbal response, and provide to the graphical user interface the textual response.

In one example, the memory containing instructions to further control the one or more processors to: generate a textual response based on some or all of the first verbal input response, and provide to the graphical user interface the textual response.

In some embodiments, the memory contains instructions to further control the one or more processors to: receive a second user input, the second first user input including a second verbal input to request information of an aspect of the physical environment, translate the second verbal input into a second text query using the first machine learning model, analyze, by the second machine learning model, the second text query to determine an inquiry result, and provide a second verbal response based on the inquiry result.

In various embodiments, the analysis of the second text query to determine the inquiry result is based on data from external data sources. In one example, the analysis of the second text query to determine the inquiry result is based on the context of the user.

In various embodiments, the verbal input may be audio or text. For example, the verbal input may be received by an audio device (e.g., microphone) or a keyboard. Similarly, the verbal response may be audio or text. For example, the verbal response may be generated to be provided by a speaker or generated to be displayed (e.g., as text). In some embodiments, the verbal input may be received in a chat session (e.g., either as a typed input or an audio input over a microphone). Similarly, the verbal output may be provided in a chat session as typed output or speaker (e.g., a speaker configured to convert text to speech or to provide the verbal response directly without converting).

A non-transitory computer-readable medium comprising executable instructions, the executable instructions being executable by one or more processors to perform a method, the method comprising: receiving a 3D digital model representing a physical environment, receiving a first user input, the first user input including an first verbal input to control navigation to a destination within the 3D model, translating the first verbal input into a first text query using a first machine learning model, analyzing, by a second machine learning model, the first text query to determine a desired navigation, and providing one or more navigational commands to control navigation to a destination within a graphical user interface associated with the 3D model responsive to the verbal input.

The example method further comprises: generating a first verbal response describing the destination based on metadata associated with the destination and the 3D model, and providing the first verbal response.

In one example, the first verbal response includes a position of the destination relative to other locations within the physical environment. In some embodiments, the first verbal response is generated based on context from the user. In some embodiments, the first verbal input is in a non-English language. In one example, the first verbal response is in a non-English language.

The example method further comprises: generating a textual response based on some or all of the first verbal response, and providing to the graphical user interface the textual response. In one example, generating a textual response based on some or all of the first verbal input response, and providing to the graphical user interface the textual response.

One example method further includes: receiving a second user input, the second first user input including a second verbal input to request information of an aspect of the physical environment, translating the second verbal input into a second text query using the first machine learning model, analyzing, by the second machine learning model, the second text query to determine an inquiry result, and providing a second verbal response based on the inquiry result.

In some embodiments, the analyzing the second text query to determine the inquiry result is based on data from external data sources. In various embodiments, the analyzing the second text query to determine the inquiry result is based on context of the user.

In various embodiments, the verbal input may be audio or text. For example, the verbal input may be received by an audio device (e.g., microphone) or a keyboard. Similarly, the verbal response may be audio or text. For example, the verbal response may be generated to be provided by a speaker or generated to be displayed (e.g., as text). In some embodiments, the verbal input may be received in a chat session (e.g., either as a typed input or an audio input over a microphone). Similarly, the verbal output may be provided in a chat session as typed output or speaker (e.g., a speaker configured to convert text to speech or to provide the verbal response directly without converting).

An example method comprising: receiving a 3D digital model representing a physical environment, receiving a first user input, the first user input including an first verbal input to control navigation to a destination within the 3D model, translating the first verbal input into a first text query using a first machine learning model, analyzing, by a second machine learning model, the first text query to determine a desired navigation, and providing one or more navigational commands to control navigation to a destination within a graphical user interface associated with the 3D model responsive to the verbal.

### BRIEF DESCRIPTION OF THE DRAWINGS

FIG. 1 depicts a block diagram of an example environment capable of receiving digital images of physical environments and providing a multi-modal assistant for voice-assisted, enhanced navigation and data retrieval within the digital images according to some embodiments.

FIG. 2 depicts an example model assistant system according to some embodiments.

FIG. 3 depicts a flowchart of a multi-modal assistant according to some embodiments.

FIG. 4A depicts steps of the flowchart of FIG. 3 for one type of navigational command according to some embodiments.

FIG. 4B depicts steps of the flowchart of FIG. 3 for another type of navigational command according to some embodiments.

FIG. 5 depicts an example user interface depicting one type of response to a navigational command presented to the model assistant system according to some embodiments.

FIG. 6A depicts an example user interface of a living room with furnishing according to some embodiments.

FIG. 6B depicts an example user interface of the living room with all furnishing virtually removed according to some embodiments.

FIG. 7 depicts an example user interface depicting removal of objects in a space in response to a navigational command presented to the model assistant system according to some embodiments.

FIG. 8 depicts an example user interface depicting a refurbishment of a space in response to a navigational command presented to the model assistant system according to some embodiments.

FIG. 9 depicts another example user interface of a room and multi-model information with further details of the room according to some embodiments.

FIG. 10 depicts steps of the flowchart of FIG. 3 for one type of an ask command according to some embodiments.

FIG. 11 depicts an example user interface highlighting one floor or story of a building in dollhouse view according to some embodiments.

FIG. 12 depicts an example user interface of a view of a front entry way of a home along with a summary of the building in textual form according to some embodiments.

FIGS. 13A-13C depict example user interfaces of a multi-modal walkthrough of a building according to some embodiments.

FIG. 14 depicts an example user interface of an aerial image of a neighborhood along with multi-modal information of the neighborhood according to some embodiments.

FIG. 15 depicts steps of the flowchart of FIG. 3 for one type of a find command according to some embodiments.

FIG. 16 depicts an example user interface of a view of a building with icons depicting wheelchair accessibility of various parts of the view according to some embodiments.

FIG. 17 depicts a block diagram of an example digital device according to some embodiments.

### DETAILED DESCRIPTION

3D models enable users to engage in virtual tours of real property. Various embodiments described herein allow people to engage with 3D models of real property in many different ways including, for example, based on physical need, preference, or a combination of both. For example, a system may enable users to engage and interact with 3D models in different modes and different ways. Similarly, the system may provide output to support navigation and/or interaction with a 3D environment in a convenient and supportive manner.

In one example, a user may request information (e.g., by providing queries by text or through an audio input) related to the navigation of a 3D model. In response, a model assistant system may provide the requested information in a form that is accessible to the user (e.g., visually, audibly, and/or the like). In one example, an interface may control navigation of a displayed 3D model based on the user's text or speech input. In another example, the interface may provide an audible description of a space in a 3D model or navigation through a 3D model depending on the needs or preferences of the user.

In some embodiments, a user may engage with a chat agent that is available in an interface that provides a visualization of the 3D model of real property. The chat agent may receive verbal input from the user (e.g., audibly over a microphone or textually over a keyboard), and control the visualization and/or provide information regarding the real property. For example, a user may provide an audio request to “see” a kitchen in the visualization of the 3D model. The chat agent may receive the audio request from the microphone (or a recording), convert the audio to text (e.g., using speech to text), and provide commands to the interface to navigate to or display the kitchen of the 3D model. In some embodiments, the chat agent may provide the text (e.g., either with or without additional processing) to an LLM to recognize the request and provide commands to control the navigation of the 3D model.

Similarly, the chat agent may receive a verbal request for more information regarding the real property depicted in the 3D model. The chat agent may provide the request to the LLM and the LLM may be configured (e.g., via a prompt) to retrieve or provide information of the property based on metadata or other information associated with the real property. For example, if the verbal input from the user is with regard to the nature of the neighborhood that includes the real property, the LLM may respond based, at least in part, using previously stored information about the neighborhood (e.g., number of homes in a subdivision, proximity to schools, proximity to parks, safety, and/or the like). The previously stored information may be based on external data from any number of sources (e.g., from a real estate agent, property records, police reports, news articles, and/or the like).

It will be appreciated that while a chat agent is described with respect to these examples, the information may be provided and responses provided with or without a chat agent. For example, the user may provide inputs to a field or with a microphone and a response (e.g., an audio response, navigation of the visualization, text response, or any combination) may be provided.

In some embodiments, a model assistant system may assist users with one or more disabilities in interacting and/or receiving information related to the 3D model. In one example, the model assistant system may provide a 3D model visualization that can be more easily seen by people with a color vision deficiency or automatically scale the visualization to assist those who need magnification of all or part of the model.

In some embodiments, users may interact with the 3D model visualization by providing queries (e.g., vocally through a microphone) to the model assistant system, thereby enabling people with visual and/or mobility disabilities to interact with the 3D model. For example, a user's verbal query may include an auditory input to the model assistant system in spoken English or any other language. The model assistant system may analyze the spoken input, translate the input if necessary, and provide the analyzed input as a prompt. The model assistant system may provide the prompt to an LLM to provide a command to the 3D model graphical user interface (GUI) or provide information. The model assistant system may provide an auditory response, in English or any other language, with an answer to the query or may assist in 3D model navigation.

It will be appreciated that, in some embodiments, the user may interact with the GUI in any number of ways, including by gesture, by voice, and/or by text. For example, a user may provide a digital video of someone communicating by sign language or they may communicate with the model assistant system using sign language over a webcam. The model assistant system may receive video and/or images that include the sign language, translate the sign language to a query, and provide a response. For example, the model assistant system may answer the query to, for example, navigate to a particular or different position in a 3D model and/or provide information (e.g., by text, speech, or both).

In some embodiments, queries may be presented to the model assistant system using a peripheral input device such as a keyboard. Alternately, queries may be presented to the model assistant system in the form of an eye gaze tracker (e.g., which may support people with physical disabilities) to navigate menus, communicate, and/or the like. The model assistant system may receive input from specialized hardware (e.g., the eye gaze tracker), translate the movement if needed (e.g., if the specialized hardware did not provide sufficient translation), and provide a response.

In some embodiments, to assist those with visual disabilities, the model assistant system may provide an auditory description of highlights of a room, floor, or story of a home, a building, or a neighborhood. Room-level description may include, for example, square footage of the room, insights, or structural details. Floor-level descriptions may include square footage, layout information, or dimensions of the architecture. Home or building level descriptions may include, for example, square footage, year the home or building or built, size of lot, number of bedrooms, number of bathrooms, highlights of the property. A neighborhood-level description may include, for example, a direction that the home or building faces, demographics of residents of the area, average household income, highlights of the neighborhood, and distance to nearby services such as grocery stores.

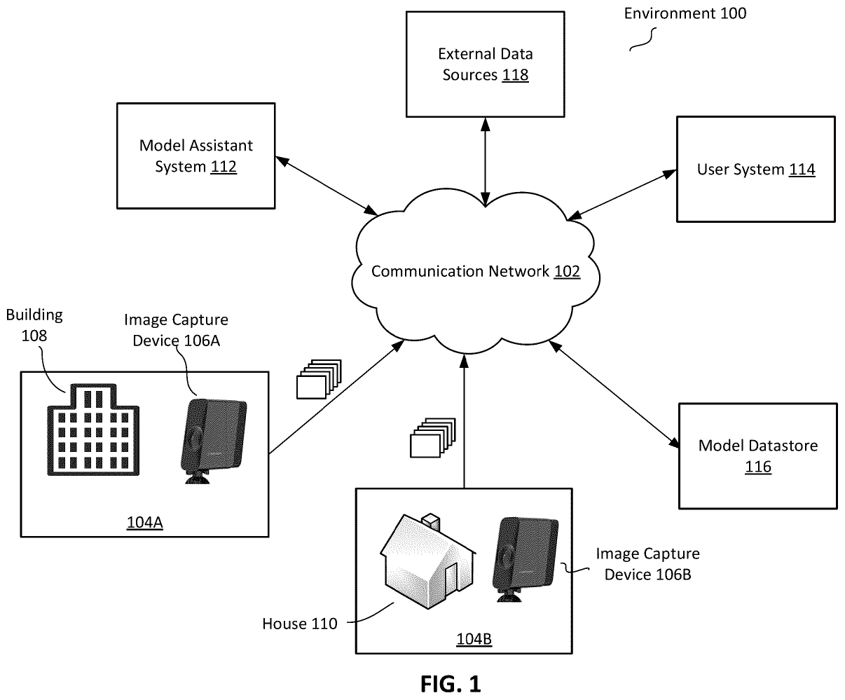

FIG. 1 depicts a block diagram of an example environment 100. The environment 100 includes a communication network 102, environment images 104A and 104B (individually, environment images 104 collectively), image capture devices 106A and 106B (individually, image capture device 106 collectively), a building 108, a house 110, a model assistant system 112, a user system 114, a model datastore 116, and external data sources 118. While FIG. 1 depicts image capture devices 106A and B as well as different structures, it will be appreciated that the model assistant system 112 may not include the generation of the 3D model itself, rather, in various embodiments, the model assistant system 112 may receive and/or process existing 3D models.

In some embodiments, the communication network 102 represents one or more computer networks (e.g., LANs, WANs, and/or the like). The communication network 102 may provide communication between or among the environment, such as the image capture device 106, the model assistant system 112, the user system 114, the model datastore 116, and the external data sources 118. In some implementations, the communication network 102 comprises computer devices, routers, cables, uses, and/or other network topologies. In some embodiments, the communication network 102 may be wired and/or wireless. In various embodiments, the communication network 102 may comprise the Internet, one or more networks that may be public, private, IP-based, non-IP based, and so forth.

In various embodiments, the environment images 104A include digital images of a physical environment, such as the interior of building 108. These images may be captured by placing one or more image capture devices 106A in different locations in the interior of building 108. In some embodiments, the environment images 104A includes digital images of an exterior of the building 108. The environment images 104A may depict enough of the interior of the building 108 (e.g., living space on every floor) such that the images may be the basis for the creation of a 3D model of the interior of the building 108.

In some embodiments, where the model assistant system 112 generates the 3D models, the digital images or video captured by the image capture device(s) 106A may be sent to the model assistant system 112. In one example, the image capture device(s) 106 may transmit the digital images to the model assistant system 112 or the model datastore 116. In some embodiments, the image capture device(s) 106 may be wirelessly coupled to a smart device and the smart device may provide digital images to the model assistant system 112. In some embodiments, the images may be downloaded to a card or other media for later uploading to the model assistant system 112.

In other embodiments, the images and/or video may be provided to a 3D generation system (not depicted in FIG. 1) to generate the 3D model. The 3D models may be stored in a model datastore 116 or with any number of 3D model service providers. The model assistant system 112 may receive or retrieve 3D models from any source.

The image capture device 106 may include sensors and/or software for identifying a position and/or an orientation. In various embodiments, the image capture device 106 may associate a position and/or orientation of the image capture device 106 with one or more images captured by the image capture device 106 at that position and/or orientation. In one example, the position of the image capture device 106 may be provided by a GPS sensor for providing GPS coordinates or any other system to assist in location. The orientation of the image capture device may be identified based on the position of the image capture device and the field of view from the lens of the image capture device. The orientation and/or position of the image capture device 106 may be determined or identified in any number of ways.

In some embodiments, the image capture device 106 is a complementary metal-oxide-semiconductor (CMOS) image sensor (e.g., a Sony IMX283˜20 Megapixel CMOS MIPI sensor with the NVidia Jetson Nano SOM). In various embodiments, the image capture device is a charged coupled device (CCD). In one example, the image capture device is a red-green-blue (RGB) sensor. In one embodiment, the image capture device 106 is an infrared (IR) sensor. The image capture device 106 may include a lens assembly to give the image capture device a wide field of view.

In some embodiments, image capture device 106 may include a depth sensor (such as LiDAR, SPAD, or structured light) to obtain depth data. Depth data may be defined as the distance between a point in the physical environment depicted in a pixel of an image captured by the image capture device to the image capture device. Alternately, in other embodiments, depth data may be obtained using multiple image sensors, such as stereo-assisted imaging, where multiple image sensors are offset by a predetermined distance. These multiple image sensors may capture substantially the same physical environment at a slight offset. Digital images captured by these multiple image sensors may be utilized by a processor to create or enhance an illusion of depth in the form of a three-dimensional image.

In still other embodiments, the depth data may be captured by a LiDAR device (not depicted in FIG. 1) that is separate from the image capture device 106. It will be appreciated that depth data from a LiDAR sensor (e.g., either as a part of or separate from the image capture device 106) may not be available.

The depth data may define depth and/or location information regarding the physical environment being scanned. The depth data may be associated with the location of objects, walls, floors, ceilings, and the like that may be the subject of the images captured by the image capture device(s).

The model assistant system 112 may optionally receive any number of two-dimensional images of the physical environment from the image capture device(s) 106. In some embodiments, the model assistant system 112 or a 3D model generation system may generate a 3D digital model of the physical environment from the images of the physical environment from the image capture device(s) 106. In one example, the model assistant system 112 may generate a 3D digital model of the physical environment from 2D digital images associated with a physical environment received from the image capture device 106. In some embodiments, the model assistant system 112 may receive 3D digital models from the model datastore 116.

In some embodiments, the model assistant system 112 may receive a 3D digital model of the physical environment captured and/or generated by a third party. The model assistant system 112 may convert data associated with the 3D digital model so that the model assistant system 112 may utilize metadata associated with the 3D digital model to provide navigational assistance information. In some embodiments, the third party may or user may provide metadata to the model assistant system 112 regarding one or more 3D digital models.

As discussed herein, the model assistant system 112 may assist a user with interacting with the 3D digital model(s). In one example, a user may provide a request to the model assistant system 112. The user may, in some embodiments, provide the request to the model assistant system 112 in any number of ways. For example, some users are visually impaired and/or otherwise disabled. A visually impaired user may not be able to utilize the traditional peripheral input device, such as a keyboard or mouse, to provide input to a user interface. In this case, for example, the user may provide an audio prompt to the model assistant system 112 by speaking into a microphone. The model assistant system 112 may translate the audio prompt into a query that is analyzed to determine how to provide a response or action (e.g., by allowing for audio control of navigation and/or providing information back to the user via speech, text, and/or the like). In some embodiments, the audio prompt may be a prompt that is a recording of a user's voice (e.g., received via a microphone) and/or the like.

It will be appreciated that the model assistant system 112 may be configured to receive verbal input. A verbal input may be an input such as an audio input (e.g., received over a microphone) or text input (e.g., in response to a text box or chat).

In some embodiments, the model assistant system 112 translates the verbal prompt into a query using speech-to-text and/or further processing to assist in query generation (e.g., rewording or clarifying an audio prompt). In one example, a multi-agent approach may be used where a first agent (e.g., an LLM) receives text of an audio prompt with a request to clarify what is meant by the text. A second agent (e.g., either the same or a different LLM) may receive the response from the first agent with a request to generate an actionable query based on the response.

In various embodiments, an audio prompt may be converted to a query by translating the audio prompt to text and then assessing the text to generate a query suitable for response. The query, for example, may include a navigation command (e.g., to navigate the 3D model), a request for information (e.g., regarding a view, the physical environment related to the 3D model or the surrounding geographic area of a physical environment modeled by the 3D model), or both.

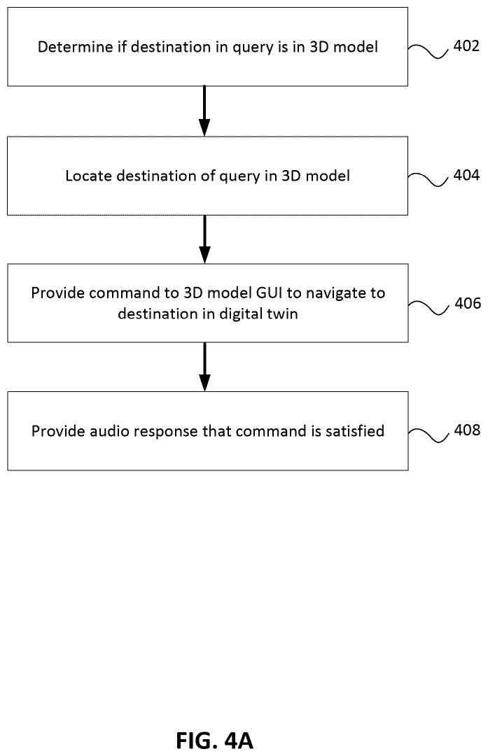

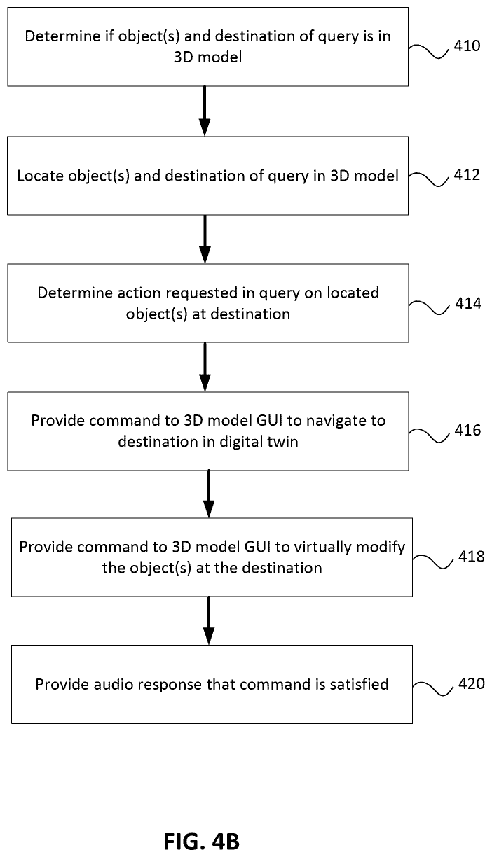

A navigation command may include an action to direct a viewpoint within the 3D model GUI to a particular part of the environment. Further details regarding the navigation command will be discussed regarding FIGS. 4A and 4B. In some embodiments, a GUI may display a destination in a visualization of a 3D model based on the query. If the query is requesting information, for example, the model assistant system 112 may provide the requested information audibly (e.g., audibly describing the destination) in addition to or instead of displaying the destination in the GUI.

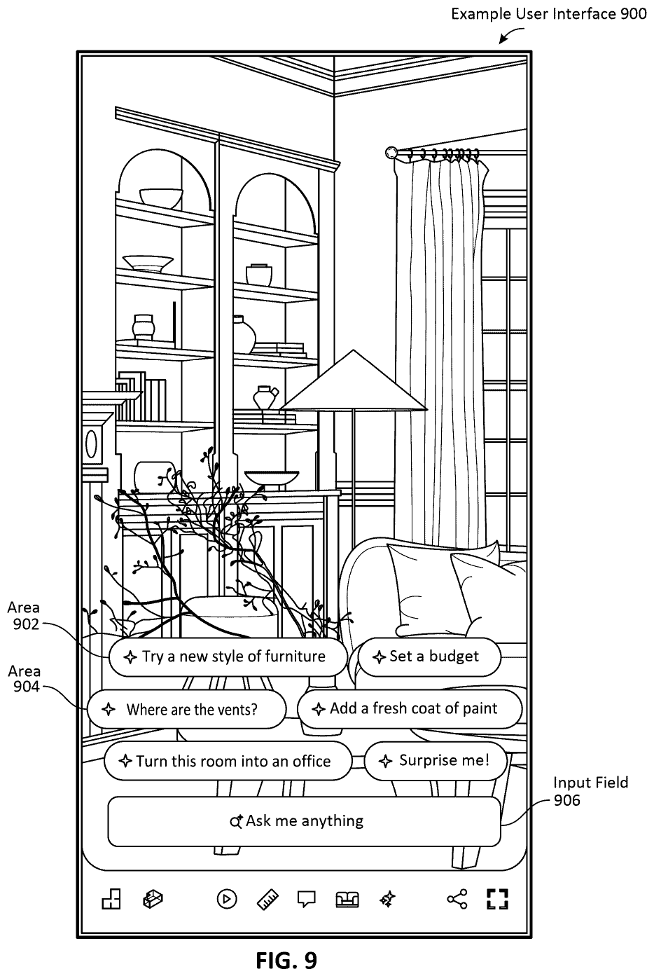

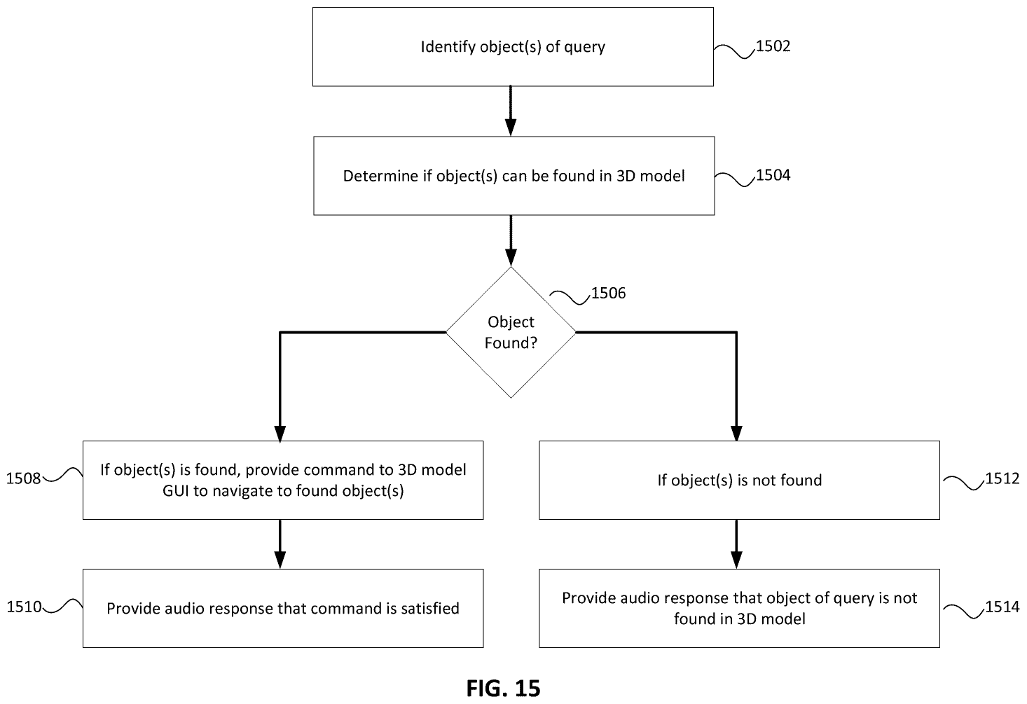

A request for information (e.g., an “ask command”) may include a request for information about the modeled environment. Further details regarding the request for information will be discussed with regard to FIG. 9. In one example, an audio input including an “ask command” may include a find command (which is a type of request for information). A find command may include a request about specific features within the physical environment modeled by the 3D model. Further details regarding the find command are discussed with regard to FIG. 15. In some embodiments, either one of the ask or find commands may require the model assistant system 112 to retrieve or receive data from one of the external data sources 118. In response to the successful completion of the command, the model assistant system 112 may provide an auditory and/or textual response to the user.

In some embodiments, the model assistant system 112 may provide or enable visualization or auditory imagery of 3D models of a physical environment. In one example, the model assistant system 112 may provide an auditory rendering of a descriptive text to “paint a word picture” of a physical environment in response to the request. For example, the request may be to describe a room or floor of the environment. Another example request may be for a description of the layout. The model assistant system 112 may determine the descriptive text to provide (e.g., using an LLM) and provide an audio response, textual response, or both.

In some embodiments, the model assistant system 112 may utilize context of the user or the user's search in preparing a response (e.g., audio, textual, or both). Context may include, for example, information such as the role of the user. For example, the model assistant system 112 may provide a different summary of a home provided to a real estate agent than the summary provided to a parent in search of a home. In one example, the model assistant system 112 In some embodiments, the model assistant system 112 may command or provide interactive actions within the GUI depicting the space. An example of this can be found in an example user interface 900 of FIG. 9. The user interface 900 depicts an image of a living room. In this example, the user may interact with area 902 to make a virtual change to the room or area 904 to find out the locations of air vents in this particular room. The user may interact with areas 902 and 904 by using traditional peripheral input devices such as a keyboard or mouse or by using a nontraditional approach such as for example, an eye gaze tracker to interact with areas 902 and 904. Alternately, instead of interacting with areas 902 and 904, the user may provide an auditory prompt or input to make a virtual change to the room. Similarly, the user may provide an auditory prompt to inquire on the location of specific aspects of a room, floor, or building (e.g., asking the number of air vents in a particular room).

Furthermore, the user may input a query in input field 906 to discover additional information about this room. In another example, the user may provide an auditory prompt or a visual input to the model assistant system 112 to discover additional information about this room. In one example, the model assistant system 112 may audibly describe actions using a speaker and receive audio input from a user (e.g., from the user's microphone). The model assistant system 112 may assess the input and take action as needed or request clarification.

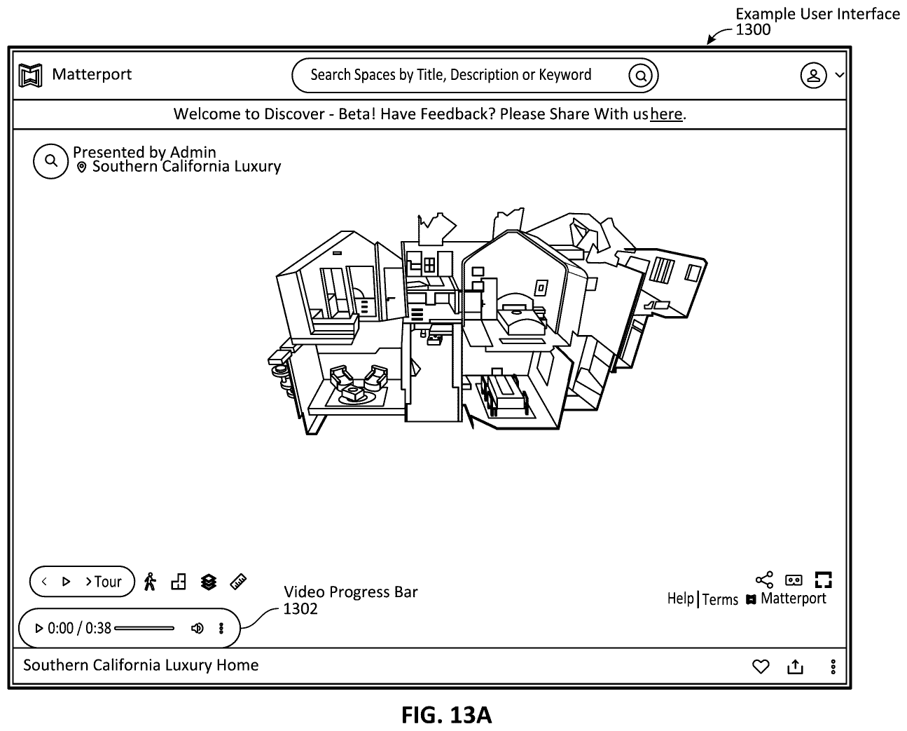

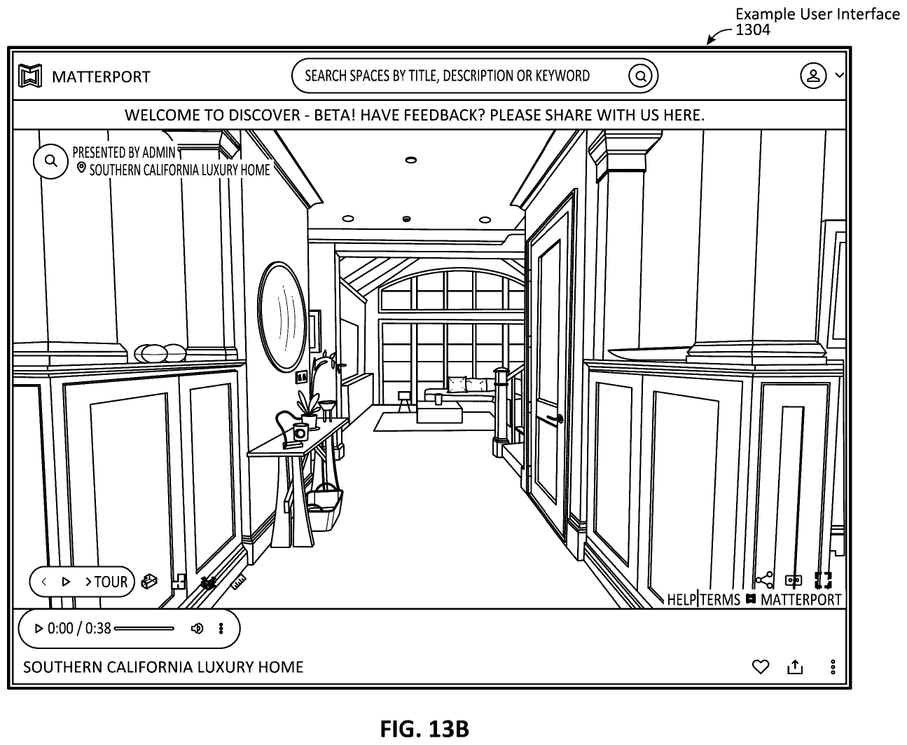

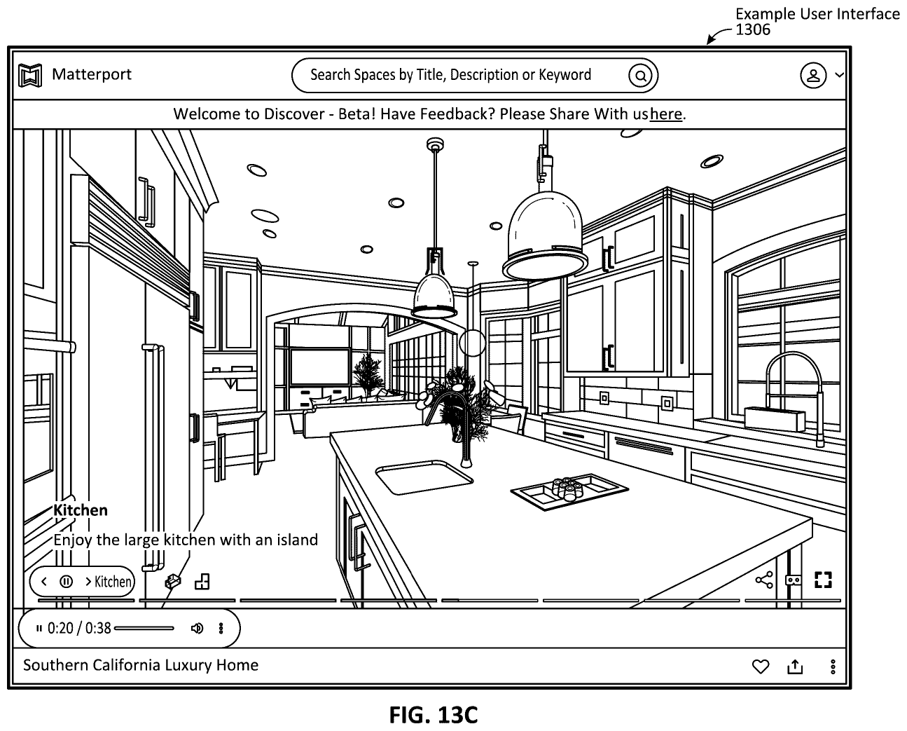

In this example, the model assistant system 112 may provide or enable visualizations and/or 3D models to allow users to perform walkthroughs of modeled environments. The model assistant system 112 may provide an interactive visualization and/or options to allow users to request information regarding one or more objects depicted in the 3D model. An example of this can be seen in FIG. 13A through 13C. These figures depict instances in a digital video walkthrough of a home.

The model assistant system 112 may execute the digital walkthrough and/or provide a descriptive auditory rendering. An overall interior view of the home may be seen by the video progress bar 1302 of an example user interface 1300 of FIG. 13A. As the video progresses, an audio voiceover may be presented to the user with highlights of each room as the visual depiction changes. The audio voiceover may be generated based on the context of the user. In one example, the contents of the audio voiceover may be generated based on metadata associated with the home or a particular area of the home being provided to the graphical user interface at the time.

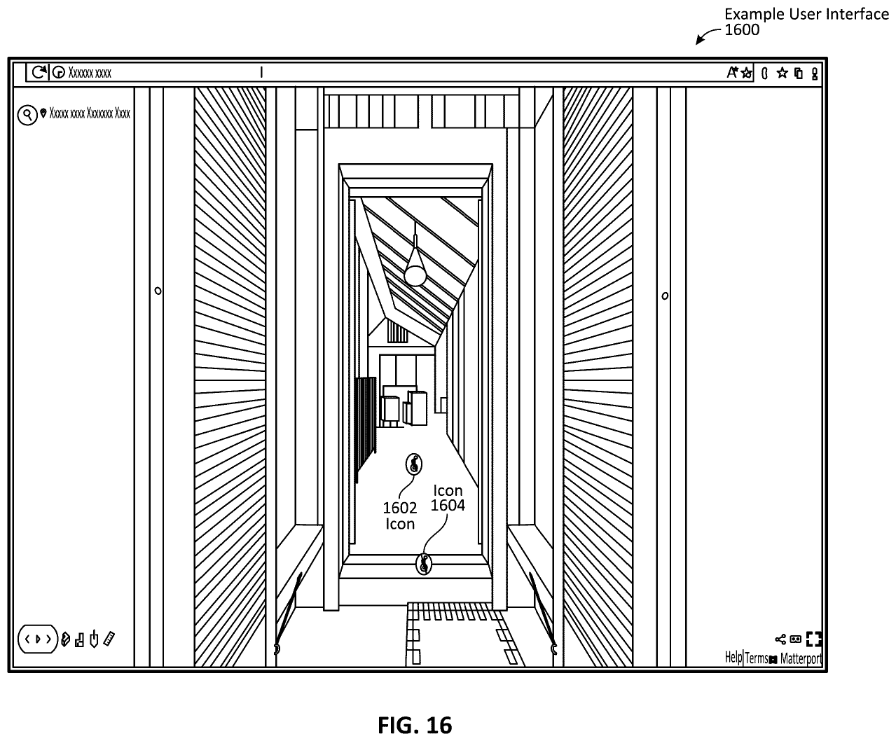

In some embodiments, the model assistant system 112 may assist in providing wheelchair-accessible paths in an environment. In one example, the model assistant system 112 may process (e.g., either preprocess before a request or after a request is received) information related to a 3D model to identify wheelchair-accessible paths. In one example, the model assistant system 112 may determine the size of paths, corridors, open space, and/or the like in portions of the modeled environment using the 3D model or information associated with the 3D models (e.g., measurements from sensors, physical measurements, analysis of images within the model to determine distances, and/or the like). The model assistant system 112 may utilize thresholding or have a criteria of the size of one or more different types of wheelchairs to identify wheelchair-accessible paths within the 3D model. Upon receiving a request for wheelchair-accessible paths, the model assistant system 112 may provide a GUI or app instructions to identify the wheelchair-accessible paths (e.g., either by a list, graphically, highlighting paths within the current view of the 3D model, a layout highlighting wheelchair-accessible paths from above, and/or the like). In some embodiments, as the user navigates through the digital rendering, the model assistant system 112 may provide commands to the GUI depicting the navigation may provide an icon to show if doors, bathrooms, hallways, etc., are wheelchair accessible. In another example, as the user navigates through doors, bathrooms, or hallways, an audio voiceover may provide an auditory indication of the wheelchair accessibility of the particular area. An example of the digital walkthrough may be seen in user interface 1600 of FIG. 16, icons 1602 and 1604.

In another example, if there are stairs in a home or building, the model assistant system 112 may provide a command to generate an icon to represent whether the stairs are accessibility compliant. As discussed above, the model assistant system 112 may process or preprocess all or a portion of the 3D model (or information related ot the 3D model) to identify stairs, dimensions of stairs, stair safety equipment (e.g., railings), and compare them to a criteria of whether they are accessibility compliant (e.g., based on common safet considerations, safety considerations provided by user, and/or government requirements). Further, in some embodiments, if the user interacts with the icon on the graphical user interface, the model assistant system 112 may provide additional information about whether the stairs are already equipped with a stair lift, or any structural changes that may be required before a stair lift can be installed.

In addition to providing visualizations and walkthroughs to enable users to view and engage with 3D models of physical environments, the model assistant system 112 may provide commands to increase or decrease the magnification of 3D visualizations and walkthroughs of the model. For example, a user may provide a request to magnify the view in the graphical user interface to enhance difficult-to-view portions. In another example, the model assistant system 112 may provide commands to increase or decrease the volume of the auditory response to make it easier for people who are experiencing hearing loss to hear.

In various embodiments, the model assistant system 112 provides (e.g., streams and/or outputs) to a digital device (e.g., the user system 114 or a remote website) all or part of a 3D model.

In some embodiments, the model assistant system 112 provides images representing the location of objects detected by the model assistant system 112 to the user system 114. In various embodiments, the model assistant system 112 may provide a tag or label that includes physical or semantic information regarding an object, such as an object category or properties of the detected object.

In some embodiments, the user system 114 is a digital device that may communicate with other digital devices and systems. A digital device is any device with a processor and memory. In some embodiments, the user system 114 may be or include one or more mobile devices (e.g., smartphones, cell phones, smart watches, tablet computers, or the like), desktop computers, laptop computers, and/or the like. In some embodiments, users may interact with the user system 114 using, for example, a web browser or mobile application to communicate with the model assistant system 112.

In some embodiments, the model datastore 116 may be any structure and/or structures suitable for captured data, such as 3D models, LiDAR data, images, and/or the like. In some examples, the model datastore 116 is an active database, a relational database, a self-referential database, a table, a matrix, an array, a flat file, a documented-oriented storage system, a non-relational No-SQL system, an FTS-management system such as Lucene/Solar, and/or the like.

The model datastore 116 may store the digital images or video captured by the image capture device 106. In some embodiments, the model datastore 116 may store three-dimensional models of an interior and/or exterior of various physical environments. Three-dimensional models may be created by the model assistant system 112. In one example, a three-dimensional model may be created by a third-party software application (not shown). For example, real-estate websites such as ZILLOW and the Multiple Listing Service (MLS) provide 2D digital images and three-dimensional models for use by real estate professionals, potential real estate buyers, and sellers to view properties for sale and rent.

In some embodiments, the external data sources 118 include 3D models and/or sources of information beyond that of the 2D and 3D digital images. It will be appreciated tha the external data sources 118 may be or include any system (e.g., web server, app, server, database, and/or the like) that may provide 3D models or other information (e.g., regarding users, 3D models, physical environments that are modeled by 3D models, and/or the like). It will be appreciated that the model assistant system 112 may retrieve or receive 3D models and/or information from any number of external data sources (e.g., using API calls).

The external data sources 118 may include websites, databases, and other sources of information related to the demographics of a particular neighborhood, school district, a direction the home or building faces and energy efficiency associated with a particular home or building.

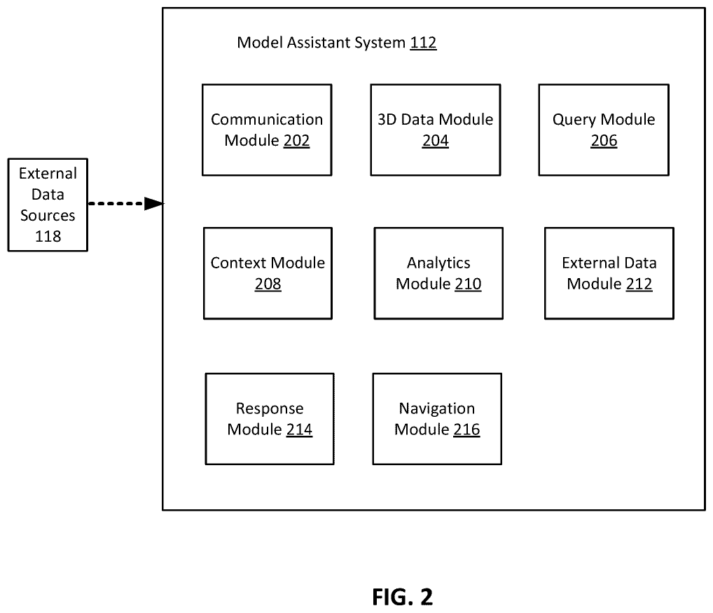

FIG. 2 depicts an example model assistant system 112 according to some embodiments. The model assistant system 112 includes a communication module 202, a 3D data module 204, a query module 206, a context module 208, an analytics module 210, an external data module 212, a response module 214, and a navigation module 216.

The communication module 202 may receive and provide information to and from the model assistant system 112 and among any number of modules within the model assistant system 112. In some embodiments, the communication module 202 may receive digital models (e.g., digital twins and digital spaces that represent real-world environments) from the model datastore 116. For example, the analytics module 210 may send a request to the model datastore 116 (e.g., web servers, web platforms, data lakes, digital devices, and/or the like) to provide one or more digital models to the communication module 202. In some embodiments, the communication module 202 may receive or retrieve 2D data, 3D data, and/or digital models, as discussed herein.

The 3D data module 204 may retrieve or receive any number of 3D models (e.g., from a third-party datastore, a local datastore, and/or the like). In some embodiments, the 3D data module may retrieve metadata associated with one or more 3D models. In various embodiments, the 3D model may include or be associated with the metadata or other information that describes the physical space modeled by the 3D model. Metadata may, for example, indicate square footage of the physical space, when the space (or building) was constructed, volume, HVAC specifications, number of outlets, number of registers, number of bathrooms, number of bedrooms, fireplace(s), location of fixtures and/or furniture, pools, water features, garage size, lot size, ceiling height, ceiling type (e.g., arched, dome, cathedral, high, low, or the like), floors (e.g., hardwood, carpet, tile), type of neighborhood, asking price, history of sales including costs, taxes, HOA fees, county taxes, state taxes, owners names, leasers'names, leasors'names, and/or the like.

In some embodiments, the model assistant system 112 may process metadata and/or otherwise enable the information to be searchable, sortable, or available (e.g., provide responses to requests) to the user (e.g., via typed and/or audio requests).

The query module 206 may receive a query or generate a query from a user input. In one example, the query module 206 may receive a typed query from a user. In this example, the user may provide a query in a text box of a GUI which is then provided or retrieved by the model assistant system 112. The query module 206 may, in some embodiments, process the query to refine or clarify the query for further processing.

In some embodiments, the query module 206 may receive audio input from the user (e.g., via a user's microphone or webcam) and convert the audio input into a text input. The query module 206 may convert the text input into a query for analysis to provide a response. For example, the audio input may be converted to a text input using speech-to-text processes. In some embodiments, the query module 206 may filter background noise and optimize for vocal sound and vocabulary. In some embodiments, the query module 206 may apply sentiment analysis to better understand the audio input and provide the understood meaning into the text input and/or the query.

In some embodiments, the query module 206 may provide all or part of the audio input or the text input into a large language model (LLM) to convert the audio input and/or text input to a query. In various embodiments, the LLM may not convert the audio input and/or text input to a query, but may rather provide a response based on the audio input and/or text input (e.g., wherein the LLM is trained and/or has access to all or some of the metadata described herein and the audio input is requesting information). In some embodiments, the LLM may provide additional information to the text input to better control a query by forming a prompt to assist for providing a response. In one example, the LLM may add text to a query to create a prompt to limit the response to only information associated with a particular real property, to limit the response to specific information or information sources, to provide navigational commands for a specific interface or API, and/or to provide context or tone for the response.

The context module 208 may retrieve or identify context associated with the query and/or audio input. For example, the context module 208 may identify a user record based on a user's username, identifier (e.g., ID or cookie), user-provided information and/or the like. The context module 208 may create and/or retrieve a user record associated with the user. The user record may, for example, indicate the demographics of the requesting user (e.g., type of disability if any, marriage status, age, nationality, economic status, children, occupation, and/or the like). The user record may also maintain a history of other models inspected (e.g., all residential, business facilities, and/or the like), as well as any input received from the user indicating desired outcome (e.g., the user provides an input indicating desire for a warehouse for work, a house to live in, a commercial property for investment, and/or the like). In some embodiments, the user may indicate (e.g., in a setting available to the model assistant system 112) the type of information and tone they wish to receive information (e.g., strictly informational, more information regarding safety, language with embellishment, and/or the like). In some embodiments, the context module 208 may retrieve user records from a third-party site and any other source to assist in providing the desired response to the user's input.

In some embodiments, the user may provide additional context by commenting on past or existing responses to indicate preference. For example, the user may provide an audio input indicating that they need different information or information in a different manner (e.g., “just facts, please” or “add additional description”). The context module 208 may assess results or select the appropriate LLM to enable the response to be appropriate for the desired output.

The analytics module 210 may analyze the query from the query module 206 to determine an appropriate response. In some embodiments, the audio input may request that a destination or direction be reached in the digital twin (e.g., the 3D model). The query module 206 may determine the destination or direction required based on the 3D model, the current position in the 3D model, and possible navigation paths to reach the destination (e.g., using one or more LLMs or determining paths and identifying the shortest path(s)). The analytics module 210 may provide the particular information and format API(s) for the navigation module 216 or a 3rd party GUI to navigate to the particular location. In some embodiments, the analytics module 210 may provide commands for an audible response describing the path. For example, the analytics module 210 may provide the path (e.g., by images or text) to an LLM to describe the path or direction in text or audio. The analytics module 210 may analyze the query to determine if there is a request for information and retrieve the information (e.g., from metadata and/or external database(s)).

In various embodiments, the analytics module 210 may analyze the query by passing the query through a trained machine learning system (e.g., CNN, forest tree, LLM, and/or the like), to retrieve the desired information or provide the commands (e.g., APIs) necessary to retrieve all or part of the needed information from different systems (e.g., external and/or internal to the system).

While LLMs can be referred to herein, it will be appreciated that a particularly trained LLM may be utilized and/or an LLM that is commercially available may be used (e.g., ChatGPT, Bard, or the like). A large language model (LLM) generally works based on a type of artificial intelligence known as machine learning, specifically using a model architecture called a transformer. LLMs are trained on vast amounts of text data collected from books, websites, articles, and other textual sources. Some embodiments discussed herein may utilize one or more LLMs that have been specifically trained on 3D models, particular navigational controls, real property, particular databases of models and/or metadata, facilities information, accessibility, measurements, furniture, assets, HVAC, construction, remodeling, and/or the like. Alternately, some embodiments discussed herein may utilize one or more commercially available LLMs such as ChatGPT.

Generally, during training, an LLM learns the patterns of language by predicting parts of sentences given the other parts. This involves adjusting internal parameters (weights) based on the errors it makes in predictions. LLMs use a transformer architecture, which relies on mechanisms called attention and self-attention. These allow the model to weigh the importance of different words in a sentence or passage regardless of their position. Generally, the model consists of multiple layers, each containing thousands of simulated neurons. These layers process inputs in parallel, which significantly speeds up the learning and operating process. Input text is broken down into tokens, which can be words or parts of words. These tokens are converted into numerical data that the model can understand. Each token is associated with an embedding, which is a vector representing that token in a high-dimensional space. These embeddings capture semantic properties of the token. To maintain the order of words, positional encodings are added to embeddings, giving the model a sense of word order within sentences. Using the context provided by the embeddings and its learned parameters, the model generates a response. It does this by predicting one word (token) at a time, using the previously generated words as additional context until it completes a sentence or reaches a stopping criterion.

In some embodiments, an LLM may receive post-initial training where the LLM can be fine-tuned on specific types of data or tasks to improve their performance in particular areas. For example, an LLM may be fine-tuned to provide commands to a GUI or API to control interaction with a 3D model, navigation, highlight aspects of the visualization, change scaling, change color, provide additional images (e.g., furniture), remove information (e.g., walls from the visualization), and/or the like. An LLM may be periodically updated with new data or adjustments in their algorithms to improve accuracy, reduce biases, and expand their knowledge.

The external data module 212 may enable the model assistant system 112 to access and/or retrieve information from third-party systems, web platforms, data base(s), and/or the like (e.g., external data sources 118). In various embodiments, the query, based on context, may need safety or crime statistics of the neighborhood surrounding the property described by the 3D model. The external data module 212 may format APIs or queries to retrieve information from external sources to provide the response module 214 to provide an appropriate response.

The response module 214 may be configured to provide the response (e.g., from the analysis module 210). In some embodiments, the response module 214 provides the response as audio, text, image, and/or the like. The response module 214 may provide the response to a GUI (e.g., 3^{rd} party 3D navigation software, server, and/or application) or directly to the user. The response module 214 may, in some embodiments, format or organize the information retrieved in response to the query before providing a response.

In some embodiments, the response module 214 may utilize context and/or other information to provide the information back in a particular desired tone. In one example, the response module 214 may generate a prompt for an LLM that includes the information to be provided to the user as well as information to describe the user (e.g., sentiment, context, applicable demographics) to generate an understandable response in a form that the user may appreciate. In some embodiments, the user may select a setting for a preferred tone and/or voice for an audible response. The response module 214 may provide the response to the user by text, audibly (e.g., using text to speech), or both.

The navigation module 216 may determine a destination or navigate a direction within the digital twin (e.g., 3D model). The navigation module 216 may, in some embodiments, depict the navigation and path in a GUI or trigger a description of the new destination by text or audibly. In various embodiments, the navigation module 216 is optional. The navigation module 216 may control the 3D model and/or provide commands to a GUI or the like to control the navigation of a 3D model.

In some embodiments, the model assistant system 112 may enable chat functionality. In one example, an interface configured to allow interactivity and/or navigation with a 3D model visualization may provide chat functionality. A user may enter a statement or question requesting information. The chat agent may provide the input to the model assistant system 112. In some embodiments, the query module 206 may receive the input from the chat agent and provide the query to an LLM. The LLM may be trained or configured to utilize the 3D model and any information regarding the 3D model (e.g., metadata, information describing the physical space, information describing the neighborhood of the physical space, map information, and/or the like) to prepare a response and return the response to be displayed to the user in the chat function. The information regarding the 3D model may be accessible by the model assistant system 112 from any number of sources (e.g., local, external, or both).

In one example, a user may provide a request of a description of a particular room of a house of a 3D model through a chat agent. The query module 206 may receive the request and retrieve information about the house from any number of external and/or local sources (e.g., via the external data module 212). The query module 206 may provide the request (e.g., either processed to generate a separate query or directly) to an LLM that is configured to utilize the information about the house to form a response including a description of the particular room. The response module 214 may provide the response to the user.

In another example, the query module 206 may receive a request asking if furniture would fit in a room of the 3D model (e.g., “would a king sized bed fit in this room? ”). The LLM and/or query module 206 may identify the room being displayed. Further, the LLM and/or query module 206 may identify dimensions of the furniture (e.g., either average size of furniture for that type or specific size if the request referred to furniture of known dimensions) by referring to the general training of the LLM (e.g., such as ChatGPT). In some embodiments, the query module 206 and/or the analytics module 210 may retrieve dimensions of the room from any number of sources, generate estimates, or calculate room sizes based on 3D model information (e.g., such as a Matterport Mesh of the 3D model which is dimensionally accurate). The LLM may determine different placement options and determine fit for the furniture and provide a response (e.g., via the response module 214) to the chat agent. In some embodiments, the LLM may provide suggestions for placement of the bed in the room.

In some embodiments, the query module 206 is a chat agent or supports any number of chat agents regarding any number of 3D models.

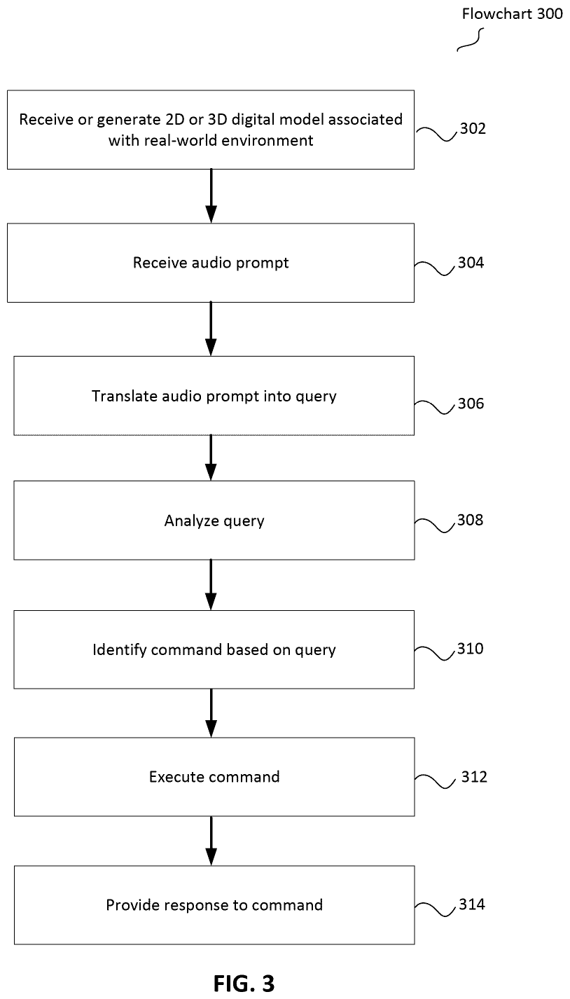

FIG. 3 depicts a flowchart 300 of a multi-modal assistant according to some embodiments. In step 302, the 3D data module 204 may receive a 3D model (e.g., digital twin) of a physical environment or physical space. In some embodiments, the 3D data module 204 may receive a 3D digital model of a physical from the model datastore 116 or an external source.

In some embodiments, the model assistant system 112 generates the 3D model. For example, the 3D data module 204 may receive 2D digital images of a physical space. The 3D data module 204 may generate a 3D model of the physical environment using the 2D digital images and depth data from the depth sensor of the image capture device.

In some embodiments, the 3D model is not received by the model assistant system 112. In one example, a user may access a 3D model on a third-party device or access a 3D model downloaded to their device. The model assistant system 112 may receive an indication that the 3D model is being accessed from the third-party device (e.g., via an API call), application, or the user. In some embodiments, the 3D data module 204 may receive an identifier that identifies the 3D model being accessed by the user. In this example, the model assistant system 112 may receive user input directly from the user device or via the third-party device or application. The model assistant system 112 may then generate a query, prepare a response, and pass audio, images, and/or commands to the third-party device or application to enable the interface to provide the audio, images, or functions (responsive to the commands).

In step 304, the query module 206 receives audio input from the user of the model assistant system 112. In some embodiments, the audio input may be an auditory prompt. In one example, the auditory input may be in the English language; it can be appreciated that the input may be in any language. In some embodiments, the received input may be in a textual form, such as a question input into a search field of a user interface. For example, the user may provide an audio input, but the audio input is converted to text input in a field by a separate system, operation system, GUI system, and/or the like (such as the input field 906 of FIG. 9). In one example, the prompt may be received in the form of a digital video. For example, a person with a speech disability may choose to utilize American Sign Language (ASL) to interact with the model assistant system 112. A user may provide a digital video of someone communicating with ASL.

In some embodiments, the input may be received by a different system such as systems designed to assist with communication or control by people with disabilities. In one example, the prompt received by the query module 206 may be received from an eye gaze tracker software to identify menu times, determine meaning, type letters, and/or the like. Eye gaze trackers are used to determine where a person is looking on a computer screen. It can be used for marketing purposes to track a user's visual movements, for example, where a user's gaze lingers.

In step 306, the query module 206 translates the prompt from the user into a query. The query may be provided to a machine learning module such as a Large Language Model (LLM). In one example, the query module 206 provides a textual representation of the query (e.g., either being received directly from a user, converted from speech-to-text, converted from gestures in video, converted from signals received from systems designed to assist disabled people, and/or the like) to one or more LLMs to generate a query that can be acted upon by the analytics module 208. In various embodiments, the query module 206 may augment, format, or modify a prompt with user input and specific instructions to assist with the prompt to receive a meaningful query from the LLM(s).

In step 308, the analytics module 210 may analyze the query. For example, if the prompt received from the user is a request to “Show me the kitchen,” the analytics module 210 may analyze the query to determine the meaning of the input in a manner that can be accomplished (e.g., by the response module and/or the navigation module). In one example, the query is identified and the kitchen in the 3D model of the home is identified as a destination. In another example, if the prompt received from the user is a request, “Which of the bedrooms is the largest,” the analytics module 210 may analyze the query by identifying the needed information, comparing size of bedrooms, and/or locating the bedrooms in the 3D model of the home.

In step 310, the analytics module 210 may identify a command or the information that is needed based on the query. In some embodiments, the analytics module 210 determines if information from the context module 208 is required. The context of the query or the user may include a query history or search history of the user. For example, if during this particular navigational session, the majority of the user's prompts are related to wheelchair accessibility and wheelchair navigation of various homes, the analytics module 210 may utilize this information if the users ask to learn about a particular home.

In some embodiments, the analytics module 210 determines if data from one or more data sources external to the model assistant system 112 is required. If external data is required, the analytics module 210 may send a request to the external data module 212. The external data module 212 may make API calls to one or more external data sources to obtain data such as the crime rate in a neighborhood.

In some embodiments, the query module 208 may provide the query to a trained LLM or other AI system and the response from the trained LLM or other AI system may be a command or action that can be passed to the navigation program of a 3D model (e.g., via a server or application) or is information to be provided audibly to the user.

In step 312, the analytics module 210 may execute the command to navigate or retrieve information for a response to the user input. In one example, commands are categorized into three categories: navigate, ask, and find. A navigate command includes an action to direct the 3D model GUI to a particular part of the physical environment. In some embodiments, the response to the navigation command may be to navigate to the requested area of the 3D model. For example, a user may provide an audio prompt to query module 206:“Show me the interior in dollhouse view.” The analytics module 210 may determine that the command associated with the query is a navigate command and configure the navigation command is needed. The analytics module 210 may send a request to the navigation module 216 to navigate the 3D model GUI to provide an interior of the home in a dollhouse view. An example of the execution of the command may be the example user interface 1300 of FIG. 13A. Once the execution of the command is successfully accomplished, the flowchart 300 can proceed to step 314.

In step 314, the response module 214 may output an auditory or text response including the desired information. The auditory response may include some highlights of the home as seen in the dollhouse view. In addition to the auditory response, the textual response corresponding to the auditory response or commentary may be provided to the 3D model GUI. In some embodiments, the contents of the auditory response and/or textual response depend on the context of the user.

In some embodiments, the result of the execution of the command may be provided in virtual reality (VR) or augmented reality (AR). The response module 214 may provide a VR or AR output to a user's AR or VR visual display equipment. More details regarding the different commands are further discussed regarding FIGS. 4A, 4B, 10, and 15.

FIG. 4A depicts some steps of the flowchart of FIG. 3 for one type of navigational command according to some embodiments. One or more of the steps depicted in FIGS. 4A and 4B may refer to a single step of the flowchart 300 of FIG. 3.

In this example, a user may provide the query module 206 with an audio prompt such as “Show me the living room.” The query module 206 translates the prompt from the user into a query. In step 402, the analytics module 210 may analyze the query and identify that the user requests to navigate to the living room. In step 404, the analytics module 210 locates the living room in the 3D model.

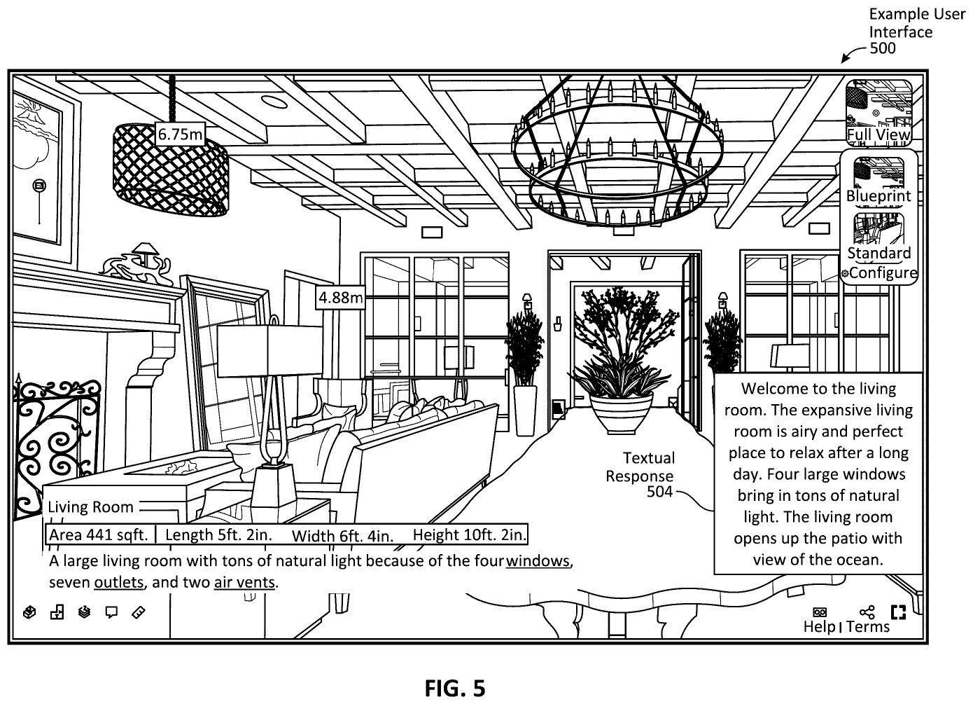

In step 406, the analytics module 210 executes the navigation command. The analytics module 210 may send a request to the navigation module 216 to navigate the 3D model GUI to provide a view of the living room. An example of the execution of the command may be the example user interface 500 of FIG. 5.

In step 408, the response module 214 may output an auditory response to a GUI (e.g., application or server associated or executing navigation or interaction with the 3D model) to be audibly provided to the user. In one example, the auditory response may include some highlights of the living room. In some embodiments, in addition to the auditory response, a textual response corresponding to the auditory response or commentary (e.g., including text of what is to be audibly communicated to the user) may be provided to the 3D model GUI. In some embodiments, the auditory response is optional. An example of the textual response can be seen in a textual response 504 of FIG. 5. In some embodiments, the textual response 504 is optional.

Subsequent to the execution of the command, the user may provide additional prompts from the user of the model assistant system 112. For example, after being provided the example user interface 500 to further interact with the particular room or another part of the home.

Other examples of navigation prompts may include (but are not limited to):
Take me to the front entrance.
Show me the aerial view of the home.
Show me the home with the street view.
Show me the kitchen.
Show me a close-up view of the fireplace mantle.

FIG. 4B depicts some steps of the flowchart of FIG. 3 for another type of navigational command according to some embodiments. This other type of navigation command includes navigating to a particular location of the 3D model and virtually modifying the particular location in some way.

In this example, a user may provide an audio prompt to query module 206:“Remove all furniture from the living room.” The query module 206 may translate the prompt from the user into a query. In step 410, the analytics module 210 may analyze the query and identify that the user wishes to navigate to the living room and remove all the furniture from that room. In step 412, the analytics module 210 may locate the living room in the 3D model and identify one or more objects in the living room that are classified as furniture.

In step 414, the analytics module 210 determines the navigation command and additionally includes a virtual modification of the furniture in the living room. Steps 412 and 414 may correspond to the step 310 of FIG. 3.

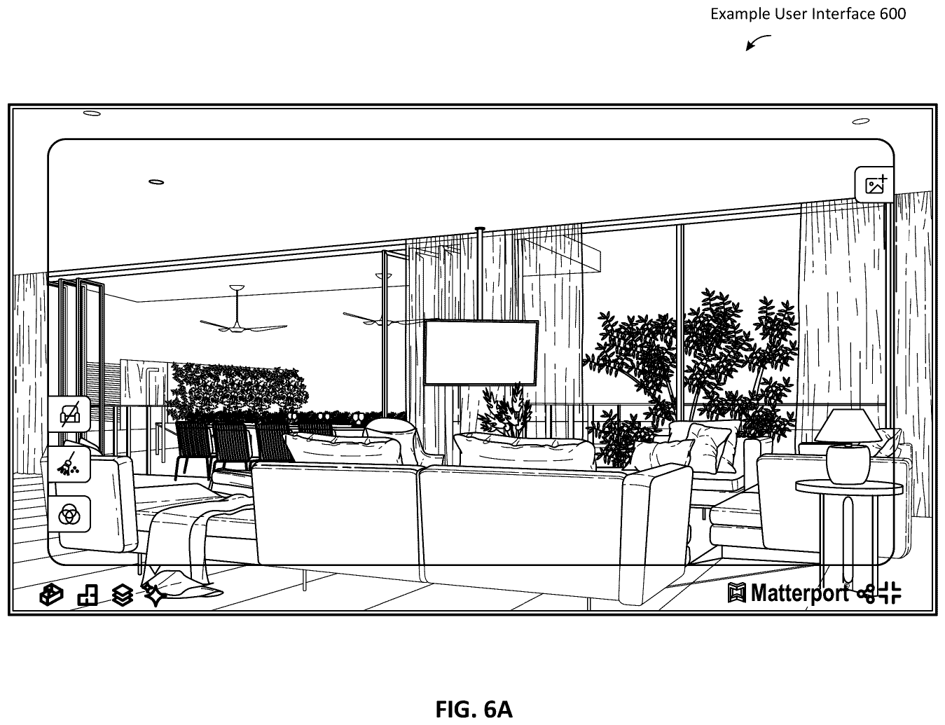

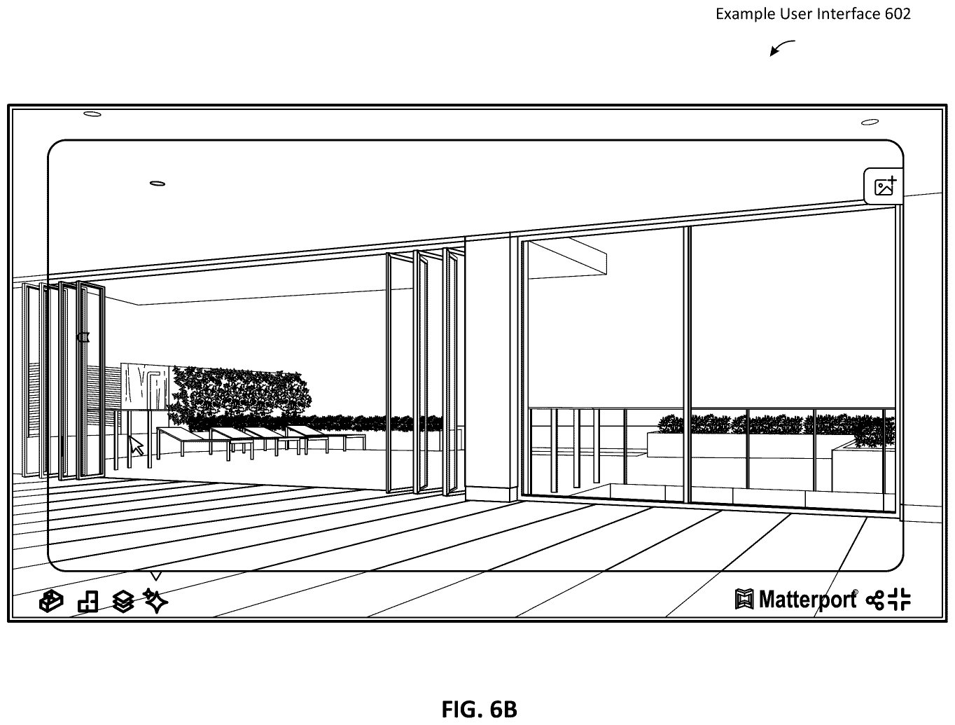

In step 416, the analytics module 210 executes the navigation command. The analytics module 210 may send a request to the navigation module 216 to navigate the 3D model GUI to provide a view of the living room. An example of the execution of the command may be the example user interface 600 of FIG. 6A.

In step 418, the analytics module 210 modifies the living room by virtually removing the furniture in the living room. An example of the execution of the command may be the example user interface 602 of FIG. 6B. In some embodiments, in addition to the visual response of providing the user interface 602, the response module 214 may output an auditory response or a textual response. The auditory response may include highlights of the room and properties of the room including dimensions of the room, number of windows, and the like. The textual response may include at least a part of the auditory response.

In this example, the model assistant system 112 may provide a 3D model GUI of the living room as seen in the 3D model and then modifies the living room by virtually removing the furniture in the living room. In one example, the model assistant system 112 skips the step of providing the living room as seen in the 3D model.

The user may choose to modify the room in other ways. For example, the user may provide an auditory prompt to change the lighting of the room. In response, the model assistant system 112 may provide the GUI a command to display a view of the room at night with some or all of the lights turned on or dimmed to simulate what the room would look like in the evening. In another example, the user may provide an auditory prompt to change the scenery outside the room. In response, the model assistant system 112 may provide to the GUI a command to display a view of the room during different times of the day, such as sunset, sunrise, or afternoon.

In step 420, the response module 214 may provide an output of an auditory response to be provide to the user. The auditory response may include some highlights of the living room. In the example of FIG. 6B, a textual response of the auditory response is not included.

Other examples of this type of navigational prompt include, but are not limited to:
Remove the island in the kitchen.
Replace the tub in the upstairs bathroom with a shower.
Add a round center table to this room.
Declutter the kitchen.

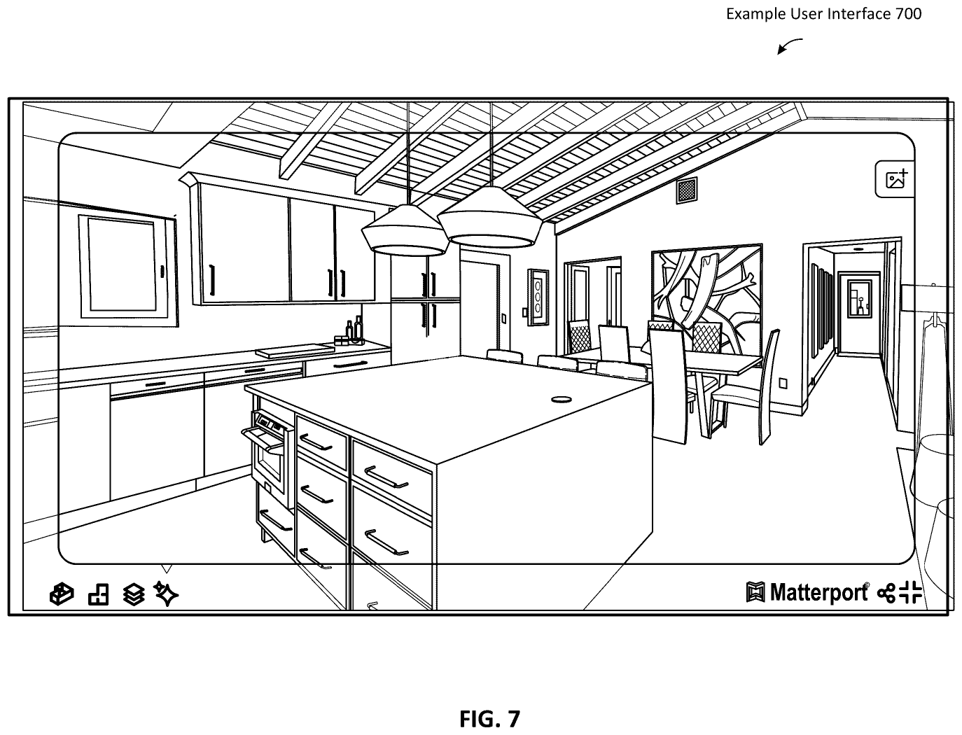

An example user interface 700 of FIG. 7 shows an example of a navigational prompt such as “declutter the kitchen.”In another example of the navigational command, the response to the navigation command may be to navigate to a particular location of the 3D model and virtually modify the particular location in some way. For example, a user may provide an audio prompt to query module 206: “Re-design the living room to an industrial look. ” In some embodiments, the graphical user interface may include an audio transcript of the audio prompt. The audio transcript may be generated by an audio-to-text converter. Many factors may affect the accuracy of the audio-to-text conversion, such as poor audio quality, language accents, and background noise. In one example, the graphical user interface may include an input field to allow a user to edit the audio transcript.

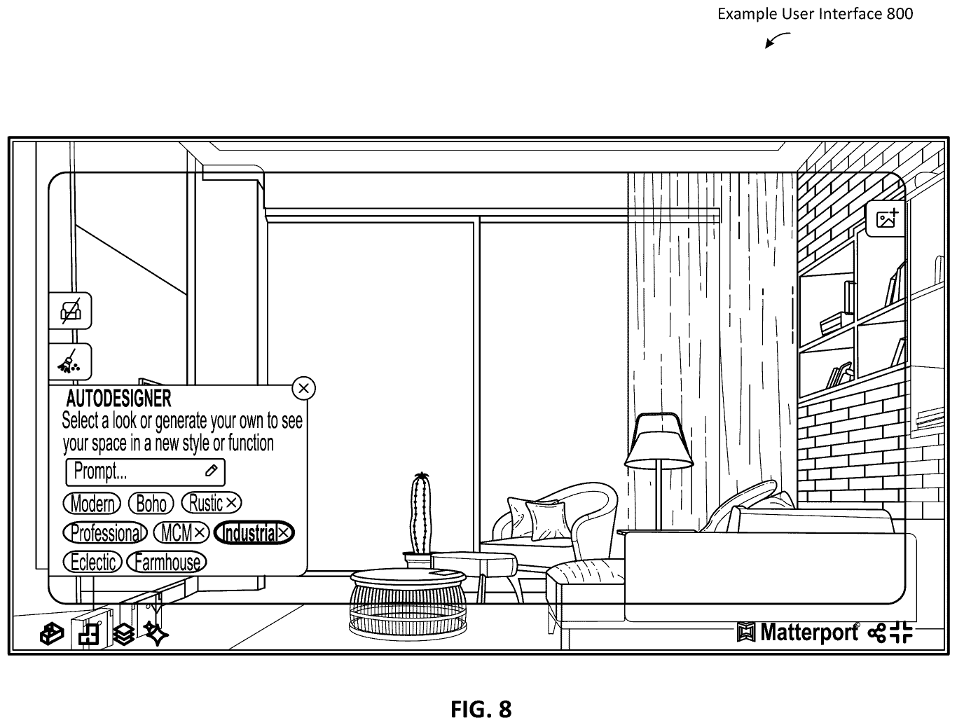

The analytics module 210 may determine that the command associated with the query is a navigate command. The response module 214 may determine that in order to execute the navigate command, the response module 214 may send a request to the navigation module 216 to navigate the 3D model GUI to provide a view of the living room in an industrial view. An example of the response provided by the model assistant system 112 may be an example user interface 800 of FIG. 8.

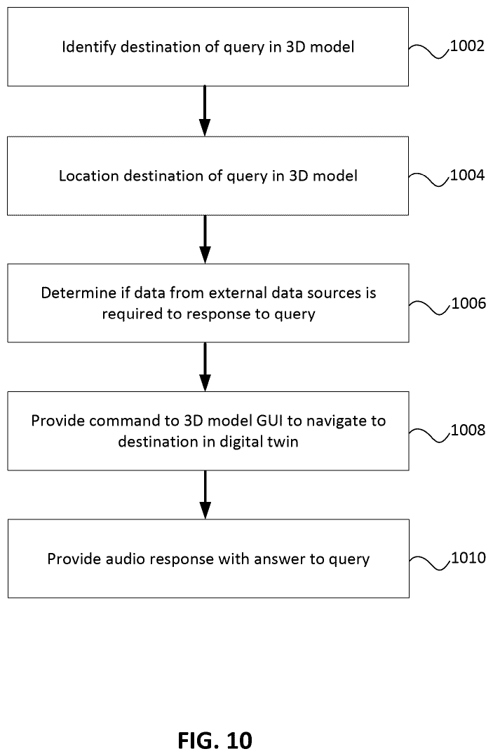

FIG. 10 depicts the steps of the flowchart of FIG. 3 for one type of an ask command according to some embodiments. One or more of the steps depicted in FIG. 9 may refer to a single step of the flowchart 300 of FIG. 3.

In one example, a user may provide the query module 206 with an audio prompt: “Tell me about the second floor of this home.” The query module 206 may translate the prompt from the user into a query (e.g., using an LLM or rules-based analytics). In step 1002, the analytics module 210 may analyze the query and identify that the user requests to see a sweeping view of the second floor of the home.

In step 1004, the analytics module 210 may locate the second floor of the 3D model. In some embodiments, the analytics module 210 determines the coordinates of the 3D model, which correspond to the boundaries of the second floor of the 3D model (e.g., using an LLM or rules-based approach).

In step 1006, the analytics module 210 determines if data from one or more data sources external to the model assistant system 112 is required to execute the command. If external data is required, the analytics module 210 may send a request to the external data module 212.

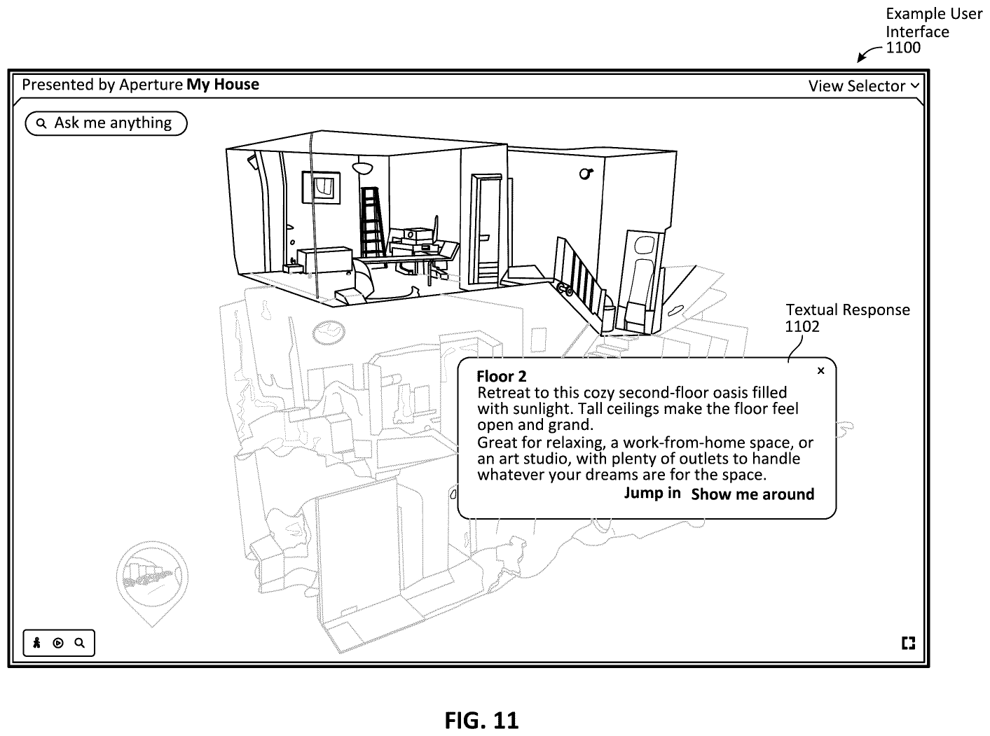

Similar to step 406 of FIG. 4A and step 416 of FIG. 4B, step 1008, the analytics module 210 executes the navigation command. The analytics module 210 may send a request to the navigation module 216 to navigate the 3D model GUI to provide a sweeping view of the second floor of the home. An example of the execution of the command may be the example user interface 1100 of FIG. 11.

In step 1010, the response module 214 may output an auditory response to be provided to the user. In this example, the auditory response may include some highlights of the second floor. In addition to the auditory response, the textual response corresponding to the auditory response or commentary may be provided to the 3D model GUI. An example of the textual response can be seen in a textual response 1102 of FIG. 11. In some embodiments, the textual response 1102 is optional. The user may interact with the user interface 1100 to obtain a closer view of one or more parts of the home.

Other examples of ask prompts include, but are not limited to:
What is the square footage of this building (or room)?
Can a king-size bed fit here?
What is the area of the walls in this room?
What color is the floor?

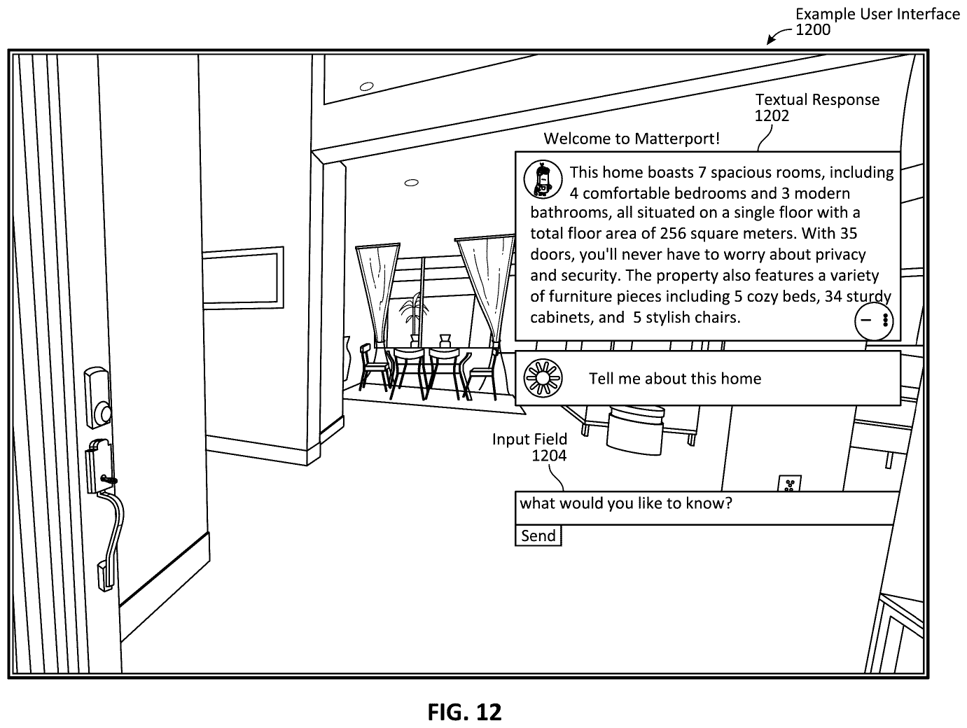

An example user interface 1200 of FIG. 12 shows the response of another example of an ask prompt such as “tell me about this home. ” In response to the ask prompt, the model assistant system 112 may provide a 3D module GUI representing the front door of the home. The user interface 1200 may display or receive a textual response 1202. The user interface 1200 includes an input field 1204, which allows users to interact with the user interface and find additional information about the home.

In the previously presented example, the 3D module GUI represents a particular room of a home. FIG. 13A-13C depicts example user interfaces of a multi-modal walkthrough of a building according to some embodiments. The response to the execution of the command may be a digital video depicting a walkthrough of the home. The response module 214 may generate a digital walkthrough and/or an auditory rendering of descriptive text. The walkthrough may begin with an overall interior view of the home, as seen in FIG. 13A. As the video progresses, an audio voiceover may be presented to the user with highlights of each room as the visual changes, for example, from the overall interior view of the home in FIG. 13A, the walkthrough video progresses to the home's entryway, as seen in an example user interface 1304 of FIG. 13B and pan around the room. The walkthrough video may continue to the kitchen; the user may interact with one or more elements of the walkthrough, as seen in an example user interface 1306 of FIG. 13C. The walkthrough and descriptions generated by the analytics module 210 may depend on the user's context.

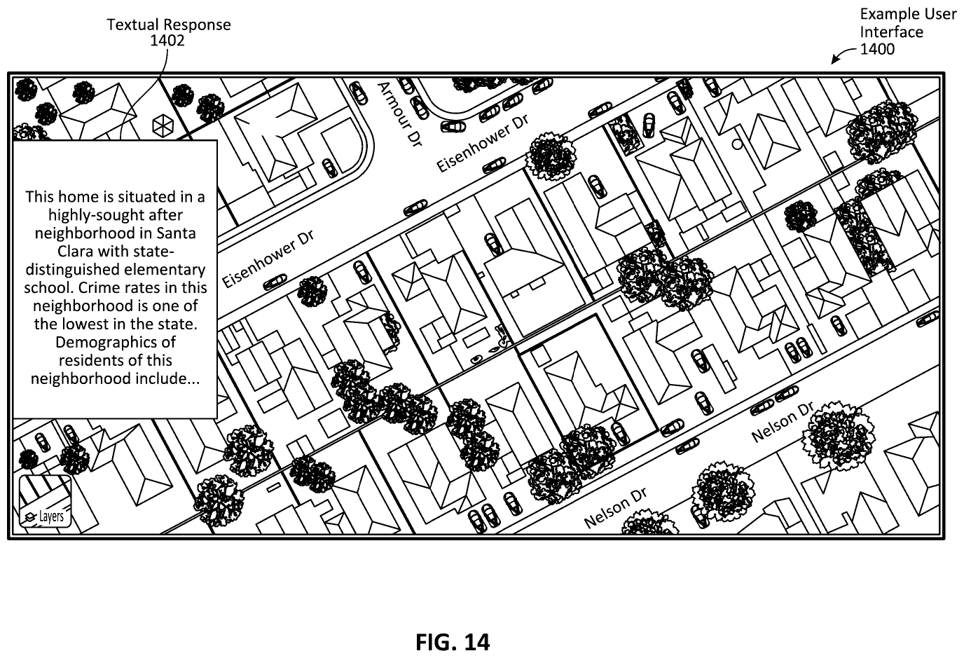

In addition to providing a multi-modal output of a room, a floor, or a home, the model assistant system 112 can provide descriptive neighborhood tours. This can be seen in an example user interface 1400 of FIG. 14. Along with the user interface 1400, which depicts an aerial image of a neighborhood, the user interface 1400 can also include an auditory response with some highlights or description of the neighborhood. In one example, the user interface 1400 includes a descriptive text or textual response 1402, the textual response 1402 may correspond to some or all of the auditory response providing information regarding the neighborhood.

FIG. 15 depicts steps of the flowchart of FIG. 3 for one type of a find command according to some embodiments.

In this example, a user may provide the query module 206 with an audio prompt such as “Is there a fence around the pool?” In step 1502, the analytics module 210 analyzes the query and determines that the query relates to a pool and a fence (e.g., using an LLM module to analyze the query). In step 1504, the analytics module 210 locates the pool in the 3D model by providing commands to a GUI or program that interacts with the 3D model (e.g., by providing API commands or the like to the software, server, and/or application).

In step 1506, the analytics module 210 receives a response to determine if there is a pool in the 3D model and if the pool includes a fence. If both objects are found in the 3D model, the flowchart proceeds to step 1508. In step 1508, the analytics module 210 executes the find command. The analytics module 210 may send a request to the navigation module 216 (or software, server, and/or application) to navigate the 3D model GUI to provide a view of the pool with the fence.

In step 1510, the response module 214 may optionally output an auditory response. The auditory response may include information regarding the pool and fence. In some embodiments, the response module 214 may determine if there is any information stored locally or in external data sources related to the pool and fence. The information (e.g., such as the year that these items were installed or updated, properties of the pool or safety features of the pool fence) may be provided to the user in auditory and/or textual form.

If a pool is not found in the 3D model, or if the 3D model includes a pool but not a fence, the flowchart proceeds to step 1512. If there is a pool in the 3D model, the analytics module 210 may send a request to the navigation module 216 to navigate the 3D model GUI to provide a view of the pool. In this example, the response module 214 may provide API calls to service providers or service information centers (e.g., social media such as reddit) for estimates of fence construction in the area of the environment depicted in the 3D model). The response module 214 may output an auditory response in step 1514 of the cost to purchase and install a pool fence, which may be installed in a pool of a particular size. In various embodiments, the auditory response may further include municipal laws regarding pool fencing.

It will be appreciated that the response module 214 may provide cost estimates or retrieve information for any item, feature, fixture, property, and/or the like. In some embodiments, the user can provide context or an indication (e.g., a setting) requesting this additional information when available or requesting that such information not be provided.

In this example, if there is no pool in the 3D model, the analytics module 210 may send a request to the software, server, or application to navigate to an area of the 3D model GUI in which a pool may be placed or installed. In this example, the response module 214 may output an auditory response in step 1514 of an estimated cost to purchase and install a pool and pool fence.

Other examples of find prompts include, but are not limited to:
Is there a half bath?
Which bathrooms have showers?
Does this home have a gas burner or an electric stove?
Does the home have energy-efficient lights?

An example user interface 1600 of FIG. 16 shows an example of the response to another find prompt, such as “Is this home wheelchair accessible?” The analytics module 210 may analyze the dimensions of various parts of the home, such as the hallway, and determine if a standard wheelchair could successfully navigate these areas (e.g., by providing API requests to a 3D mesh, software, server, application or the like or, alternately, making measurements as described herein). The analytics module 210 may further determine if the home includes wheelchair-accessible ramps, elevators, or stairs lifts or if there is space in the home to make it wheelchair accessible.

An icon 1602 of the example user interface 1600 represents that that particular area of the home represented by the example user interface user interface 1600 is wheelchair accessible. An icon 1604 of the example user interface 1600 represents that the particular area of the home is not wheelchair accessible due to the step that separates one part of the home from the other.

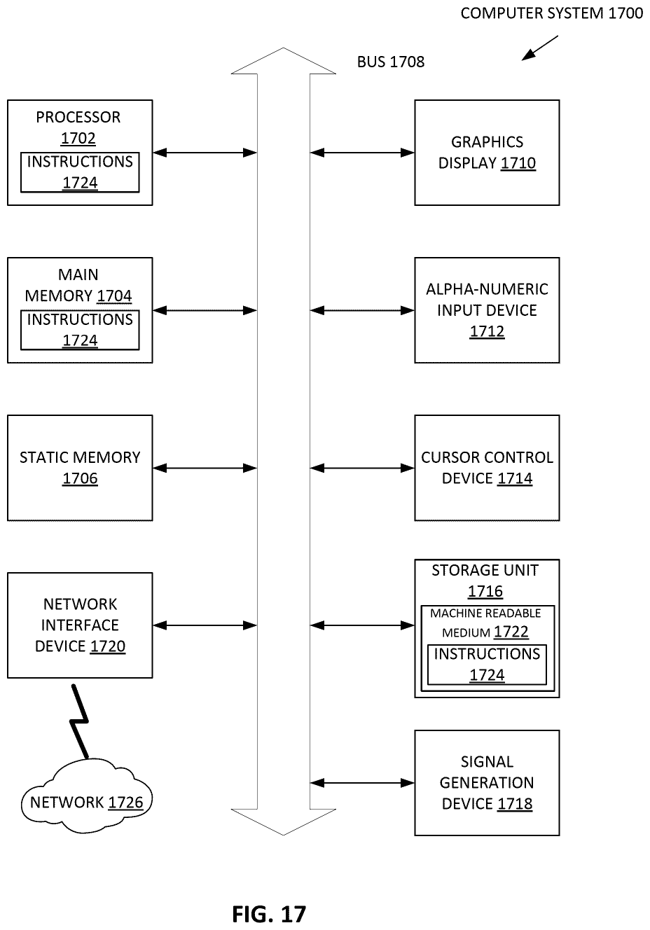

FIG. 17 is a block diagram illustrating entities of an example machine able to read instructions from a machine-readable medium and execute those instructions in a processor to perform the machine processing tasks discussed herein, such as the engine operations discussed above. Specifically, FIG. 17 shows a diagrammatic representation of a machine in the example form of a computer system 1700, within which instructions 1724 (e.g., software) for causing the machine to perform any one or more of the methodologies discussed herein may be executed. In alternative embodiments, the machine operates as a standalone device or may be connected (e.g., networked) to other machines, for instance, via the Internet. In a networked deployment, the machine may operate in the capacity of a server machine or a client machine in a server-client network environment or as a peer machine in a peer-to-peer (or distributed) network environment.

The machine may be a server computer, a client computer, a personal computer (PC), a tablet PC, a set-top box (STB), a personal digital assistant (PDA), a cellular telephone, a smartphone, a web appliance, a network router, switch or bridge, or any machine capable of executing instructions 1724 (sequential or otherwise) that specify actions to be taken by that machine. Further, while only a single machine is illustrated, the term “machine” shall also be taken to include any collection of machines that individually or jointly execute instructions 1724 to perform any one or more of the methodologies discussed herein.

The example computer system 1700 includes a processor 1702 (e.g., a central processing unit (CPU), a graphics processing unit (GPU), a digital signal processor (DSP), one or more application-specific integrated circuits (ASICs), one or more radio-frequency integrated circuits (RFICs), or any combination of these), a main memory 1704, and a static memory 1706, which are configured to communicate with each other via a bus 1708. The computer system 1700 may further include a graphics display unit 1710 (e.g., a plasma display panel (PDP), a liquid crystal display (LCD), a projector, or a cathode ray tube (CRT)). The computer system 1700 may also include alphanumeric input device 1712 (e.g., a keyboard), a cursor control device 1714 (e.g., a mouse, a trackball, a joystick, a motion sensor, or other pointing instrument), a data store 1716, a signal generation device 1718 (e.g., a speaker), an audio input device 1726 (e.g., a microphone) and a network interface device 1720, which also are configured to communicate via the bus 1708.

The data store 1716 includes a machine-readable medium 1722 on which are stored instructions 1724 (e.g., software) embodying any one or more of the methodologies or functions described herein. The machine-readable medium 1722 may be a non-transitory computer-readable medium that contains the instructions 1724. The instructions 1724 (e.g., software) may also reside, completely or at least partially, within the main memory 1704 or within the processor 1702 (e.g., within a processor's cache memory) during execution thereof by the computer system 1700, the main memory 1704 and the processor 1702 also constituting machine-readable media. The instructions 1724 (e.g., software) may be transmitted or received over a network (not shown) via network interface 1720. The instructions 1724 may be executable by one or more processors to perform steps or one or more methods as discussed herein.

While machine-readable medium 1722 is shown in an example embodiment to be a single medium, the term “machine-readable medium” should be taken to include a single medium or multiple media (e.g., a centralized or distributed database or associated caches and servers) able to store instructions (e.g., instructions 1724). The term “machine-readable medium” shall also be taken to include any medium that is capable of storing instructions (e.g., instructions 1724) for execution by the machine and that causes the machine to perform any one or more of the methodologies disclosed herein. The term “machine-readable medium” includes, but should not be limited to, data repositories in the form of solid-state memories, optical media, and magnetic media.

In this description, the term “module” refers to computational logic for providing the specified functionality. A module can be implemented in hardware, firmware, and/or software.

Where the modules described herein are implemented as software, the module can be implemented as a standalone program but can also be implemented through other means, for example, as part of a larger program, as any number of separate programs, or as one or more statically or dynamically linked libraries. It will be understood that the named modules described herein represent one embodiment, and other embodiments may include other modules. In addition, other embodiments may lack modules described herein and/or distribute the described functionality among the modules in a different manner. Additionally, the functionalities attributed to more than one module can be incorporated into a single module. In an embodiment where the modules are implemented by software, they are stored on a computer-readable persistent storage device (e.g., hard disk), loaded into the memory, and executed by one or more processors as described above in connection with FIG. 17. Alternatively, hardware or software modules may be stored elsewhere within a computing system.

As referenced herein, a computer or computing system includes hardware elements used for the operations described here regardless of specific reference in FIG. 17 to such elements, including, for example, one or more processors, high-speed memory, hard disk storage and backup, network interfaces and protocols, input devices for data entry, and output devices for display, printing, or other presentations of data. Numerous variations from the system architecture specified herein are possible. The entities of such systems and their respective functionalities can be combined or redistributed.

1. A system comprising:
one or more processors; and
memory containing instructions to control the one or more processors to:
receive a 3D digital model representing a physical environment;
receive a first user input, the first user input including an first verbal input to control navigation to a destination within the 3D model;
translate the first verbal input into a first text query using a first machine learning model;
analyze, by a second machine learning model, the first text query to determine a desired navigation; and
provide one or more navigational commands to control navigation to a destination within a graphical user interface associated with the 3D model responsive to the verbal input.

2. The system of claim 1, wherein the memory containing instructions to further control the one or more processors to:
generate a first verbal response describing the destination based on metadata associated with the destination and the 3D model; and
provide the first verbal response.

3. The system of claim 2, wherein the first verbal response includes a position of the destination relative to other locations within the physical environment.

4. The system of claim 1, wherein the first verbal response is generated based on context from the user.

5. The system of claim 2, wherein the first verbal input is received via a microphone and the first verbal response is generated to be provided by an audio speaker.

6. The system of claim 2, wherein the first verbal input is received via a microphone and the first verbal response is to be provided as text.

7. The system of claim 2, wherein the memory containing instructions to further control the one or more processors to:
generate a textual response based on some or all of the first verbal response; and
provide to the graphical user interface the textual response.

8. The system of claim 1, wherein the memory containing instructions to further control the one or more processors to:
generate a textual response based on some or all of the first verbal input response; and
provide to the graphical user interface the textual response.

9. The system of claim 1, wherein the memory containing instructions to further control the one or more processors to:
receive a second user input, the second first user input including a second verbal input to request information of an aspect of the physical environment;
translate the second verbal input into a second text query using the first machine learning model;
analyze, by the second machine learning model, the second text query to determine an inquiry result; and
provide a second verbal response based on the inquiry result.

10. The system of claim 9, wherein analyze the second text query to determine the inquiry result is based on data from external data sources.

11. The system of claim 1, wherein the first verbal input is received from a chat session.

12. A non-transitory computer-readable medium comprising executable instructions, the executable instructions being executable by one or more processors to perform a method, the method comprising:
receiving a 3D digital model representing a physical environment;
receiving a first user input, the first user input including an first verbal input to control navigation to a destination within the 3D model;
translating the first verbal input into a first text query using a first machine learning model;
analyzing, by a second machine learning model, the first text query to determine a desired navigation; and
providing one or more navigational commands to control navigation to a destination within a graphical user interface associated with the 3D model responsive to the verbal input.

13. The non-transitory computer-readable medium of claim 12, wherein the method further comprises:
generating a first verbal response describing the destination based on metadata associated with the destination and the 3D model; and
providing the first verbal response.

14. The non-transitory computer-readable medium of claim 13, wherein the first verbal response includes a position of the destination relative to other locations within the physical environment.

15. The non-transitory computer-readable medium of claim 12, wherein the first verbal response is generated based on context from the user.

16. The non-transitory computer-readable medium of claim 13, wherein the first verbal input is received via a microphone and the first verbal response is generated to be provided by an audio speaker.

17. The non-transitory computer-readable medium of claim 13, wherein the first verbal input is received via a microphone and the first verbal response is to be provided as text.

18. The non-transitory computer-readable medium of claim 12, wherein the method further comprises:
generating a textual response based on some or all of the first verbal response; and
providing to the graphical user interface the textual response.

19. The non-transitory computer-readable medium of claim 12, wherein the method further comprises:
generating a textual response based on some or all of the first verbal input response; and
providing to the graphical user interface the textual response.

20. The non-transitory computer-readable medium of claim 12, wherein the method further comprises:
receiving a second user input, the second first user input including a second verbal input to request information of an aspect of the physical environment;
translating the second verbal input into a second text query using the first machine learning model;
analyzing, by the second machine learning model, the second text query to determine an inquiry result; and
providing a second verbal response based on the inquiry result.

21. The non-transitory computer-readable medium of claim 20, wherein the analyzing the second text query to determine the inquiry result is based on data from external data sources.

22. The non-transitory computer-readable medium of claim 20, wherein the first verbal input is received from a chat session.

23. A method comprising:
receiving a 3D digital model representing a physical environment;
receiving a first user input, the first user input including an first verbal input to control navigation to a destination within the 3D model;
translating the first verbal input into a first text query using a first machine learning model;
analyzing, by a second machine learning model, the first text query to determine a desired navigation; and
providing one or more navigational commands to control navigation to a destination within a graphical user interface associated with the 3D model responsive to the verbal.
